(19) United States
(12) Patent Application Publication
(10) Pub. No.: US 2010/0111520 A1
(43) Pub. Date: May 6, 2010

(54) MULTIPLE INTERCONNECTED BROADCAST AND SELECT OPTICAL RING NETWORKS WITH REVERTIBLE PROTECTION SWITCH

(75) Inventor: Winston I. Way, Irvine, CA (US)

Correspondence Address: IPxLAW Group LLP, 95 South Market Street, Suite 570, San Jose, CA, 95113, US

(73) Assignee: VELLO SYSTEMS, INC., Milpitas, CA (US)

(21) Appl. No.: 12/619,529

(22) Filed: Nov. 16, 2009

Related U.S. Application Data
(63) Continuation of application No. 11/416,796, filed on May 2, 2006.
(60) Provisional application No. 60/677,060, filed on May 2, 2005.
(60) Provisional application No. 60/677,087, filed on May 2, 2005.

(51) Int. Cl. H04B 17/00

(52) U.S. Cl. 398/3; 398/59

(57) ABSTRACT

Optical communication networks having multiple interconnected optical rings and optical protection switching mechanism to reduce communication delays and improve optical signal-to-noise ratios. Optical ring networks using variable optical attenuators for protection switching are also described.

This application is a Continuation of and claims the benefit of U.S. patent application Ser. No. 11/416,796, entitled “Multiple interconnected broadcast and select optical ring networks with revertible protection switch”, filed May 2, 2006, which claims priority to U.S. Provisional Patent Applications No. 60/677,060 entitled “Multiple interconnected broadcast and select optical ring networks with protection switch” and No. 60/677,087 entitled “Protection Switching with Variable Optical Attenuators in Optical Ring Networks,” both filed on May 2, 2005. The entire disclosures of the above three patent applications are incorporated by reference as part of the specification of this application.

### BACKGROUND

This application relates to optical communication networks.

Optical ring networks use one or more optical ring paths to optically link optical communication nodes. Each optical ring path may be formed by fibers or other optical links. Such optical ring networks may include only a single fiber ring in some implementations and two separate fiber rings in other implementations. Either uni-directional or bi-directional optical communication traffic may be provided in optical ring networks. Different communication protocols and standards may be used in optical ring networks, such as the Synchronous Optical Network (SONET) standard and others. Optical ring networks may be used in various applications, including the access part of a network or the backbone of a network such as interconnecting central offices.

An optical ring network may experience a failure from time to time to cause an unexpected break point in the signal traffic. For example, a fiber may break open caused by, e.g., a fiber cut. As another example, an optical component such as an optical amplifier may fail. A protection switching mechanism may be implemented in optical ring networks to maintain the proper operations of the networks.

### SUMMARY

This application describes optical communication networks having multiple interconnected optical rings and optical protection switching mechanism to reduce communication delays and improve optical signal-to-noise ratios. Optical ring networks using variable optical attenuators for protection switching are also described.

These and other implementations, examples and variations are now described in greater detail in the drawings, the detailed description and the claims.

### BRIEF DESCRIPTION OF THE DRAWINGS

FIGS. 1, 2, 3, 4A-4D show exemplary ring networks with protection switching.

FIGS. 5A, 5B and 5C show exemplary junction nodes that couple two or more optical rings to form interconnected ring networks.

FIG. 6 shows a service area with optical communication nodes to be connected into a network.

FIGS. 7A and 7B show two operating conditions of a single fiber ring formed with the nodes in FIG. 6.

FIGS. 8A, 8B and 8C show examples of two interconnected rings formed with the nodes in FIG. 6.

FIGS. 9A and 9B show examples of four interconnected rings formed with the nodes in FIG. 6.

FIGS. 10A-10D and 11A-11C show examples of dual-fiber ring networks using variable optical attenuators for protection switching.

FIGS. 12A-12E and 13 show examples of single-fiber ring networks using variable optical attenuators for protection switching.

FIG. 14 show optical supervision channel signaling in a ring network.

### DETAILED DESCRIPTION

This application describes multiple interconnected broadcast and select optical ring networks with protection switching. Network configurations for interconnecting multiple rings and a protection switching mechanism are provided to maintain the communication traffic to operating nodes, to reduce the delay in rerouting the communication traffic, and to reduce the maximum transmission distance between any two points in a network when a fiber break occurs.

Optical protection switching may be implemented in ring optical networks to ensure, when a failure occurs at a location in the network, the continuous communication traffic amongst the nodes that are not at the location of the failure. In addition, during the normal operation of a ring when there is no optical failure, the optical protection switching may be configured to maintain a single optical break point in a ring or each ring of a network with two or more interconnected rings to prevent formation of a closed optical loop in each ring which can lead to re-circulating of light and thus undesired laser oscillation due to the presence of optical amplifiers in the ring.

Such optical protection switching may be implemented as a hub switch in a special hub node in ring networks. When there is no optical failure, the hub switch is open to create an optical break point and the optical traffic flows in the ring amongst hub node and other nodes on the ring without going through the hub switch. When an optical failure occurs, the hub switch is closed to allow the traffic, which is currently blocked by the optical failure, to transmit through the hub. In a dual fiber ring network, the hub includes two hub switches that are respectively connected in the two fiber rings to control the respective traffic flows in the two fiber rings. U.S. Patent Publication No. US 2003/0025961 entitled “Broadcast and select all optical network” and filed Jun. 19, 2002 (Ser. No. 10/178,071) by Winston Way discloses some implementations of such a protection switching mechanism in single-fiber and dual-fiber ring networks. Also, see U.S. Patent Publication No. US 2003/0180047 entitled “Fully protected broadcast and select all optical network” and filed Jan. 6, 2003 (Ser. No. 10/338,088) by Winston Way. The entire disclosures of the above U.S. Patent Publication Nos. 2003/0025961 and 2003/0180047 are incorporated by reference as part of the disclosure of this patent application.

Protection switching may also be implemented in ring networks in other configurations. Variable optical attenuators and optical amplifiers may be used as switching elements to turn on or off the light path. An VOA can be configured to have a maximum optical attenuation and a minimum optical attenuation where the maximum optical attenuation is set to suppress the optical transmission such that the VOA essentially operates like an optical switch in an open position. An optical amplifier may be operated as an optical switch by switching on and off the pump laser that optically pumps the optical amplifier and the switching speed may be, e.g., within 50 msec. In addition, the ring network designs and protection switching described in U.S. Pat. No. 5,680,235 entitled “Optical multichannel system” may also be used in the systems described in this application and the disclosure of the U.S. Pat. No. 5,680,235 is incorporated by reference as part of the specification of this application.

The optical protection switching may also be implemented with optical switches in all of the optical nodes in each ring within the network so that the optical protection switching can take place at any of the operating nodes within each ring when there is an optical failure. Specific examples for such protection switching are described in U.S. Pat. No. 5,680,235. In some implementations, all nodes may be configured in the same node design to eliminate the special hub with the hub switches. Optical ring networks described in this application and in the cited references may also be designed with variable optical attenuators (VOAs) inside optical network nodes in each ring to provide control over signal strengths such as adjusting the inter-span optical loss between networks nodes and to operate as part of the protection switching mechanism of the ring network.

In the above networks, one or more optical supervision channels (OSCs) are implemented to manage and operate the protection switching mechanism according to predetermined control algorithms for maintaining a single break point (or a single break span) in each ring path. Such control algorithms may be specific to the configurations of the ring networks and may vary from one ring network to another.

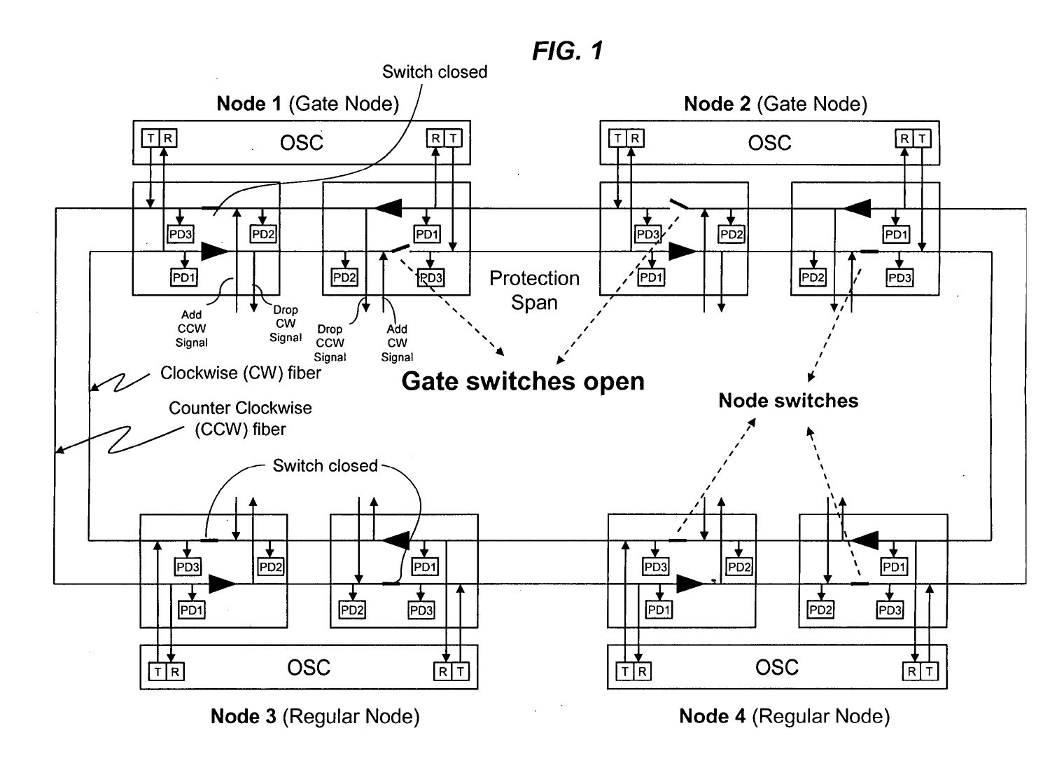

A number of node configurations may be used to implement the protection switching in each node. FIGS. 1, 2 and 3 illustrate three node configurations for dual-fiber ring networks where two separate fibers carry the same traffic in two opposite directions.

In FIG. 1, a dual fiber ring network includes network nodes with two separate node switches respectively connected in the two fibers, a clockwise (CW) fiber and a counter clockwise (CCW) fiber. Each node includes an OSC module with OSC transmitters and receivers for OSC signals in the two separate fibers, two separate node switches respectively connected in the two fibers, and two separate node optical amplifiers respectively in the two fibers. In the illustrated implementation, two identically constructed node switch modules are symmetrically connected to the two fibers where one switch module controls switching in one fiber and the other switch module controls switching in the other fiber. Photodetectors PD1, PD2 and PD3 are coupled to the two fibers as illustrated in each node switch module to optically sense the signal traffic to determine whether there is a loss of signal at a different location in the ring network. The OSC signals are coupled to the two fibers via the two node switch modules. In this design, all nodes are identically constructed to allow for the optical protection switching to be carried out at any selected node and to allow for flexible and dynamic protection switching according to specific optical failure in the ring network.

The ring network in FIG. 1 is a broadcast and select network in the sense that each node can broadcast a signal to all nodes and select one or more desired channels from multiple channels in the network to receive. Optical couplers can be used to drop the CCW and CW signals from the CCW and CW fibers and add CCW and CW signals to the CCW and CW fibers. Such add and drop functions are illustrated for the node 1 only but can be implemented in each node in FIG. 1 and in other ring networks described in this application. Some implementations of the add/drop functions in a node are described and illustrated in the cited references. Other implementations are also possible.

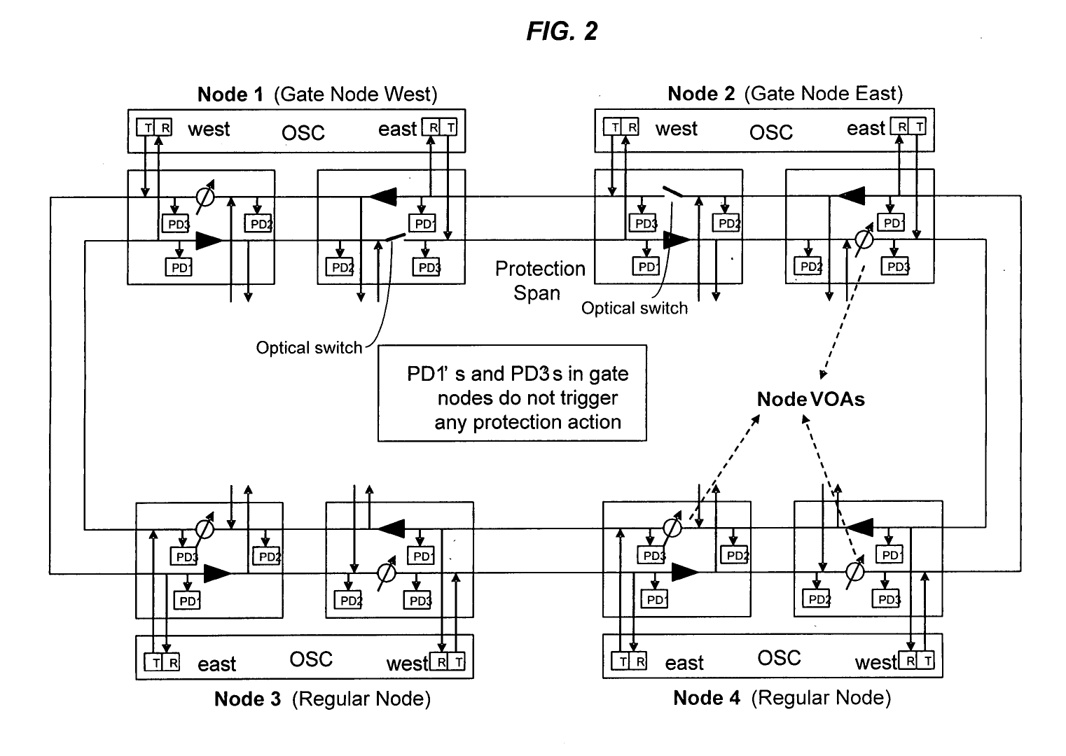

FIG. 2 shows a different node design in a dual fiber ring where there are two gate nodes and regular nodes. The two gate nodes, Nodes 1 and 2, have two gate switches, respectively, with one gate switch in one fiber and the other gate switch in the other fiber. Other optical nodes in the ring network, such as nodes 3 and 4, are “regular” nodes where each node includes two node VOAs respectively coupled to the two fiber rings and does not have an optical switch. Each node VOA can be used to (1) provide control over signal strengths such as adjusting the inter-span optical loss between networks nodes and (2) operate as part of the protection switching mechanism of the ring network, and (3) used for the purpose of achieving automatic switch reversion. The switching between the two attenuation states in an VOA for the protection switching should be within 50 msec. The VOA can be used to implement the automatic switch reversion, i.e., automatic switching back to the maximum attenuation after the fiber break is repaired, because when the fiber break is repaired, some leakage light though the VOA can be detected at the other side of the fiber break and the presence of this leakage light can be used as an indicator that the repair is completed. Hence, the leakage light through the variable optical attenuator next to the fiber break is monitored and measured while the fiber break is being repaired. Upon detection of the leakage light after the fiber break is repaired, the attenuation of the variable optical attenuator is decreased to allow for optical transmission while simultaneously opening the optical link in the gate node. In operation, each VOA can be controlled to operate in an “attenuator/switch on” mode where the optical attenuation is set to adjust the signal strength while still allowing the signal to transmit through, and in a “switch off” or “darkened” mode where the attenuation is set to the maximum at which a signal is severely attenuated to be effectively turned off and to prevent circulation of light in the fiber. The gate node 1 includes a first add/drop unit, “A/D West,” that adds the OSC signal and new add signal to the counter clockwise (CCW) fiber ring (west) where the node VOA is in the CCW fiber ring. The gate node 1 also includes a second add/drop unit, “A/D East,” that adds the OSC signal and new add signal to the clockwise (CW) fiber ring (west) where the gate switch No. 1 is in the CW fiber ring. The node gate 2 is similarly constructed except that the gate switch No. 2 is in the CW fiber ring and the node VOA is in the CW fiber ring.

In FIGS. 1 and 2, each optical switch can be implemented by a VOA and or a switchable optical amplifier. In FIG. 2, for example, the two gate switches in nodes 1 and 2 can be replaced by two VOAs. The following sections describe operations of the ring in FIG. 2. However, it is understood that the switching operations can also applicable when one or more VOAs are replaced by optical switches or optical amplifiers, or one or more optical switches are replaced by VOAs and optical amplifiers. For example, the operations described below for FIG. 2 where each regular node uses VOAs for switching can be applicable to the ring in FIG. 1 where each regular node uses two optical switches for switching.

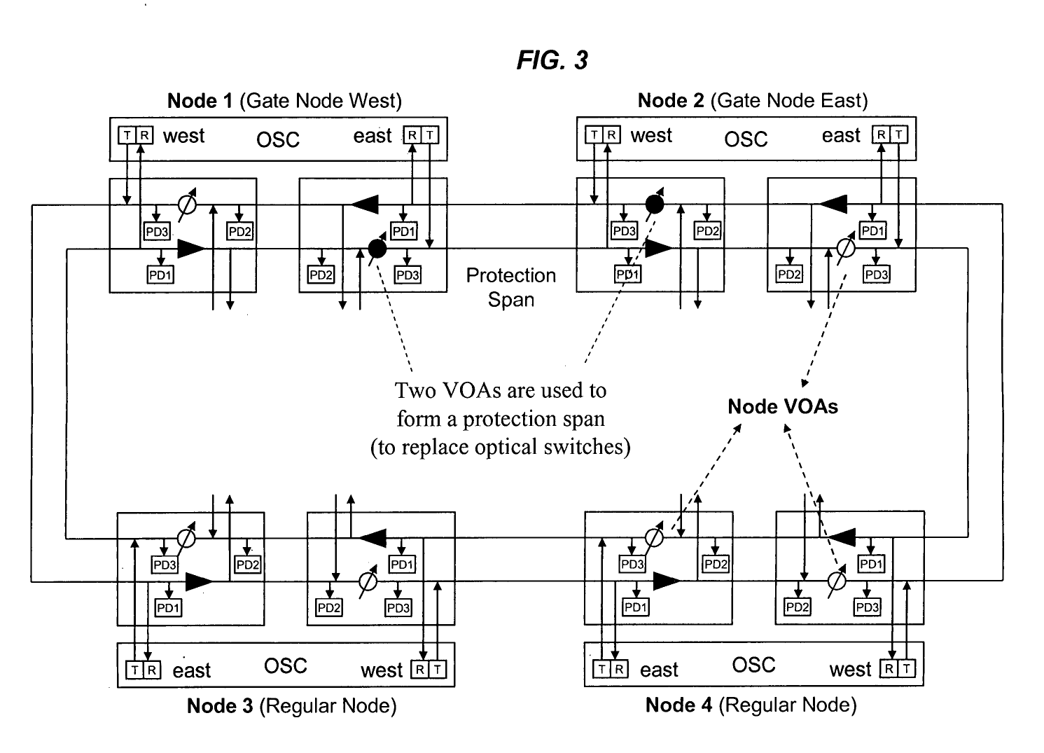

FIG. 3 shows a different node design in a dual fiber ring where all nodes are identically constructed with two VOAs respectively coupled in the two separate fibers. This design is similar to the node design in FIG. 1 except that each switch is replaced by a VOA. Like in FIG. 1, there are no fixed locations necessary for gate nodes because all nodes are identical in their structures and connections to the fibers. As a result, the selection of gate nodes becomes much more flexible and dynamic than the ring network in FIG. 2. Each VOA is configured to operate in the “attenuator/switch on” mode and the “switch off” mode.

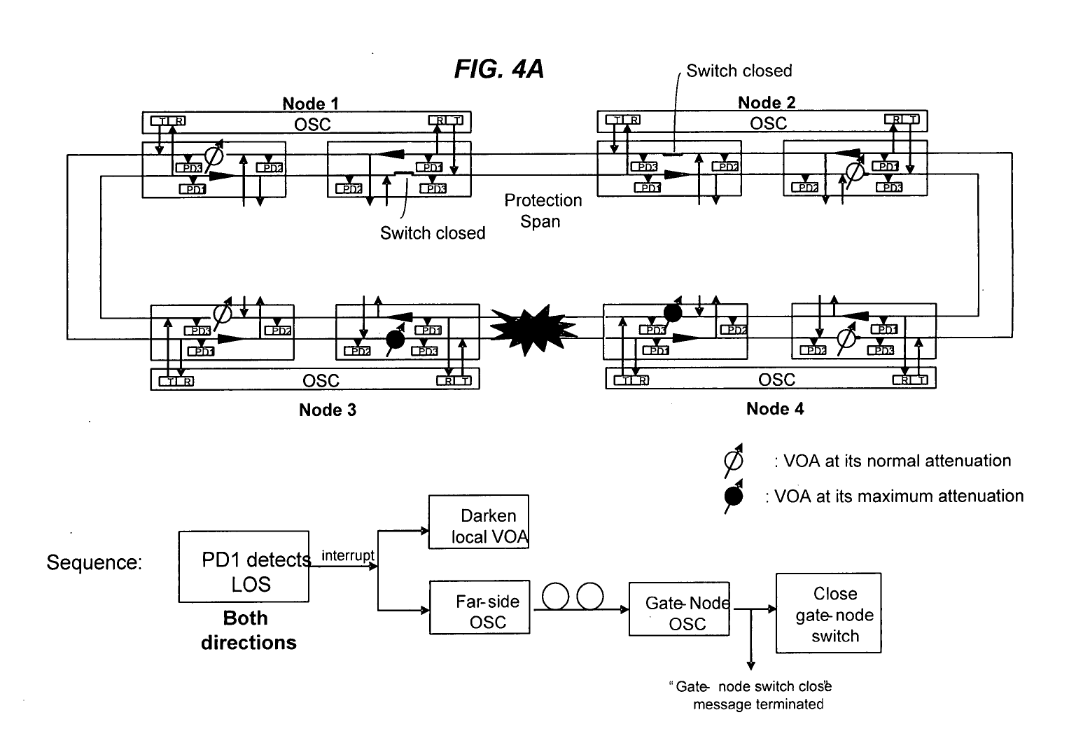

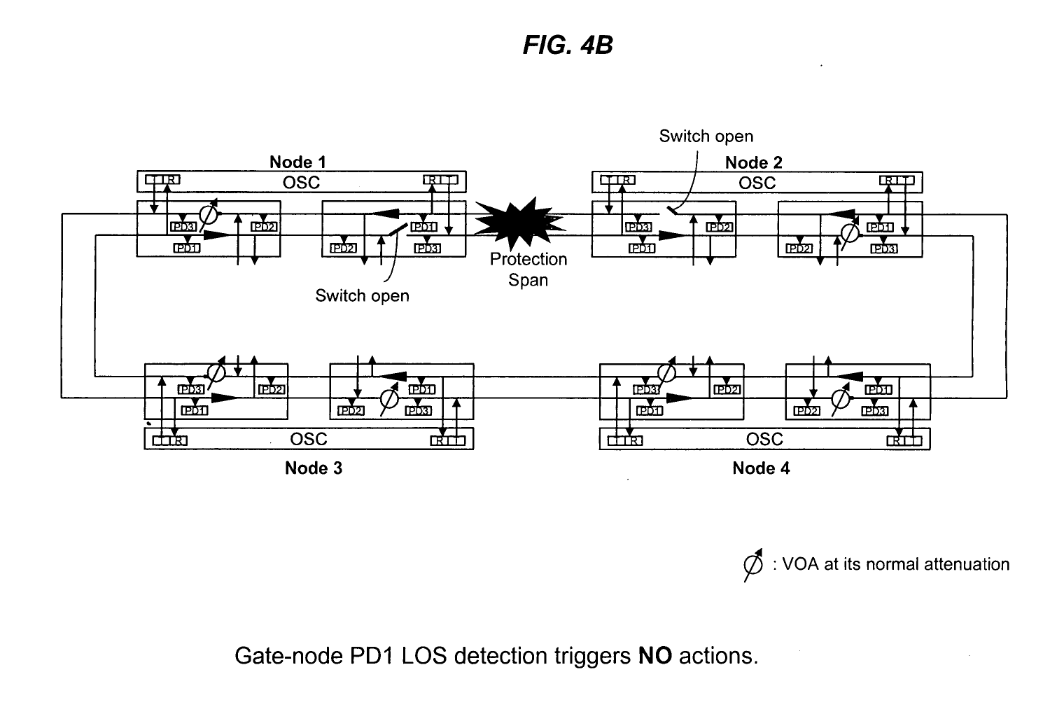

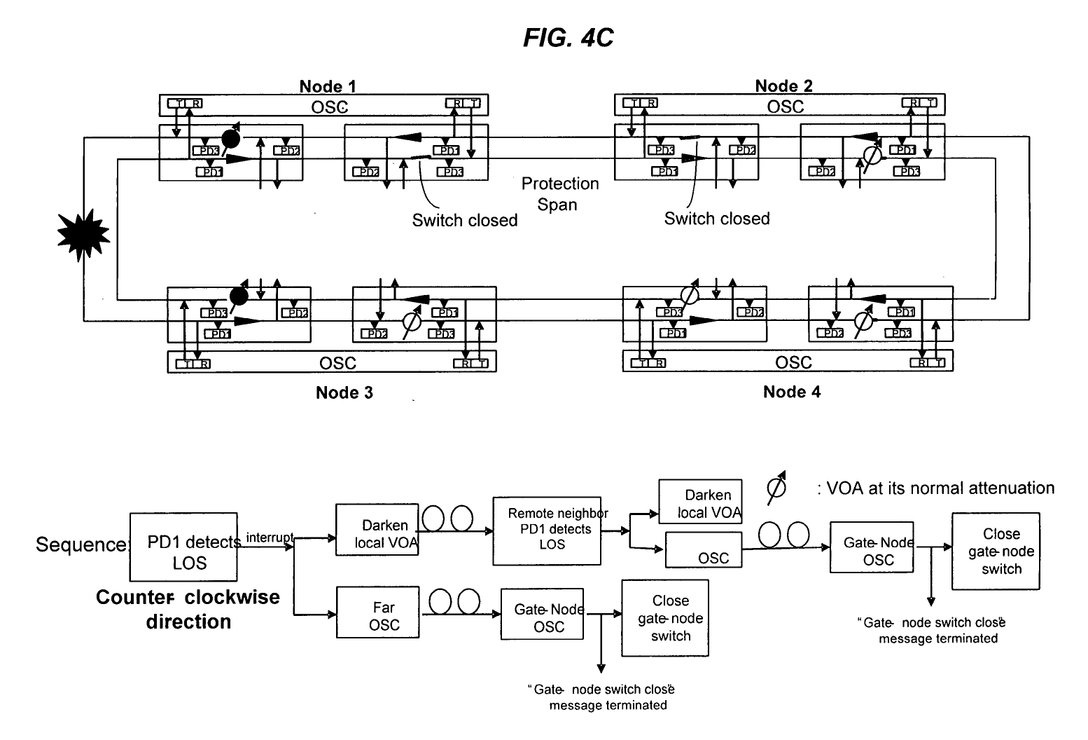

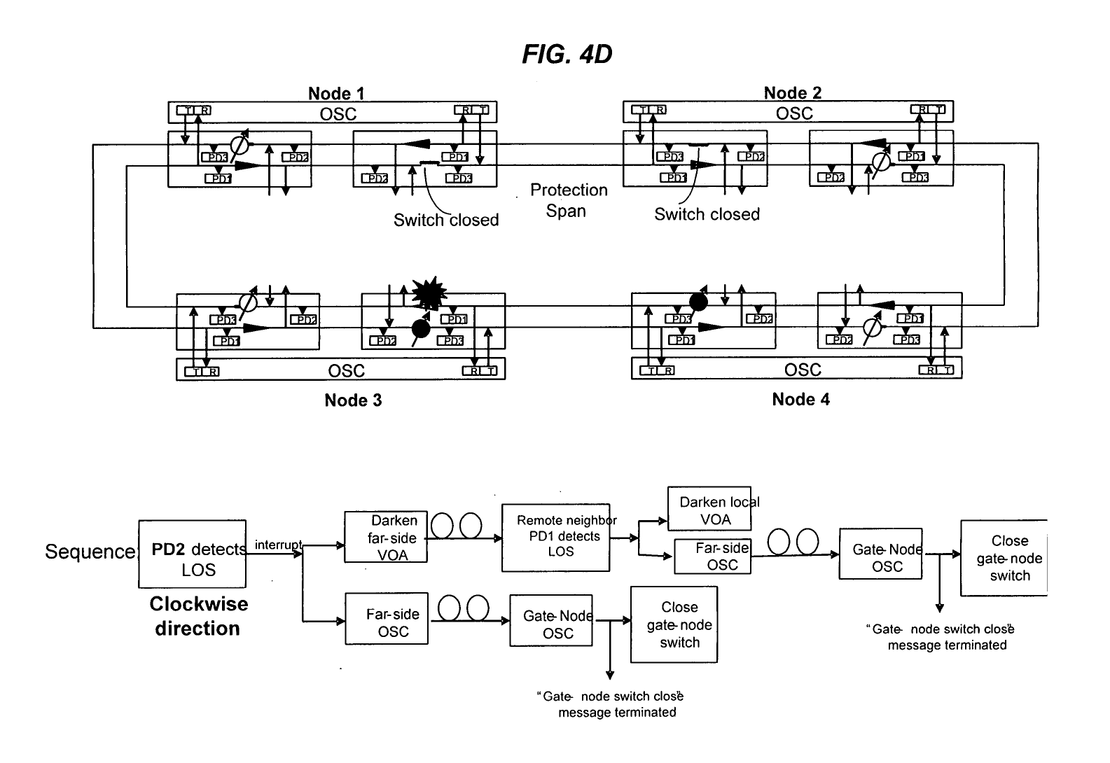

The protection switching in the ring network in FIG. 2 can be operated as follows. FIG. 2 shows the switches and node VOAs under a normal condition. FIG. 4A shows the close of the gate node switches, and the “darkening” of fiber-cut-adjacent node VOAs to operate each darkened VOA in the “switch off” mode when there is a fiber cut. FIG. 4B shows that no action is taken when something breaks within the broken span between the two gate nodes 1 and 2 with gate switches. FIG. 4C shows when there is only a single fiber break, both gate-node switches are closed, while the node VOAs surrounding the fiber cut are “darkened” in the “switch off” mode. FIG. 4D shows when there is an optical amplifier failure, both gate-node switches are closed, while the local node VOA and the neighbor node VOA are “darkened.”

The protection switching in FIGS. 1 and 3 can be understood based on the operations in the network in FIG. 2. Different from the network in FIG. 2, the networks 1 and 3 can operate any two adjacent nodes as the gate nodes to create the protection span. This allows the networks in FIGS. 1 and 3 to dynamically adjust their protection switching location.

In FIG. 4C, when there is a single fiber break, two nearby VOAs are darkened to block optical transmission in both fibers because both gate switches in nodes 1 and 2 are closed due to the break. The reason why the VOAs can be used to replace optical switches or optical amplifiers is because a certain level of optical attenuation should sufficient to prevent lasing in the fiber ring and multipath interference in a broadcast and select network.

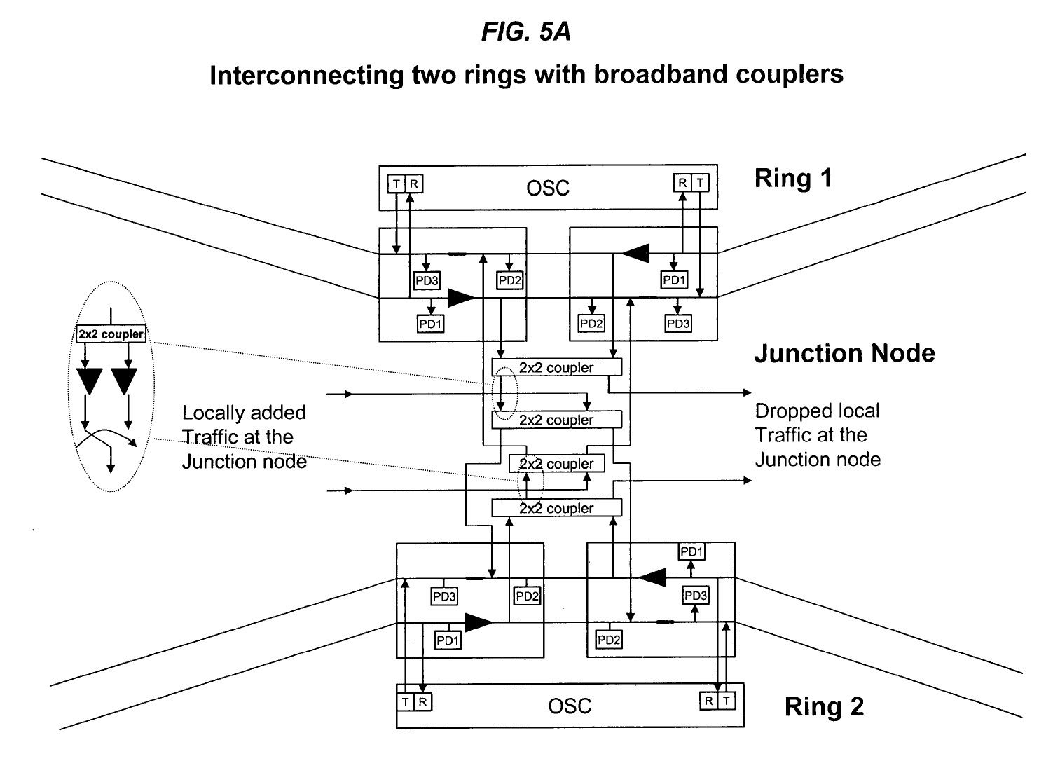

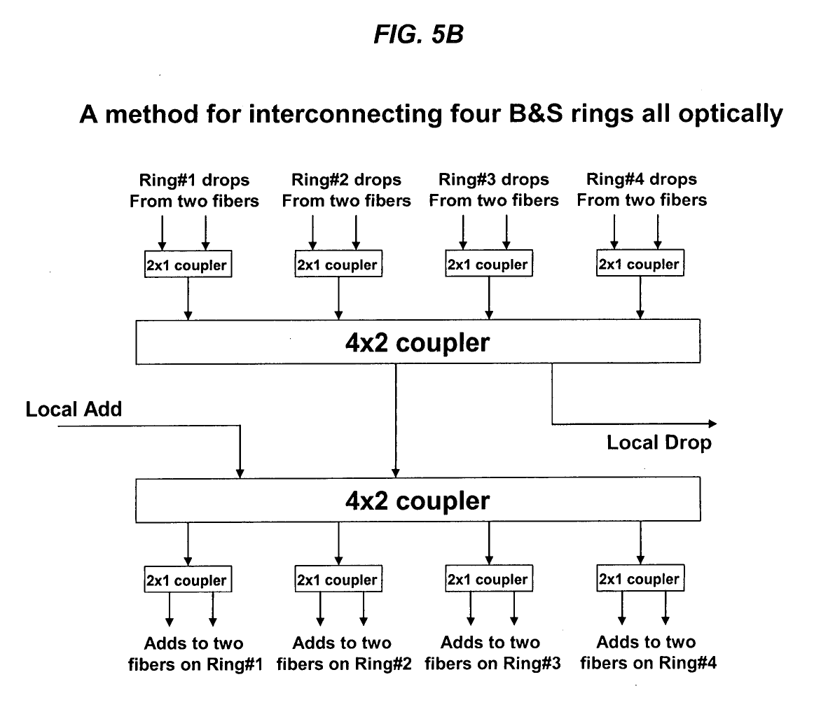

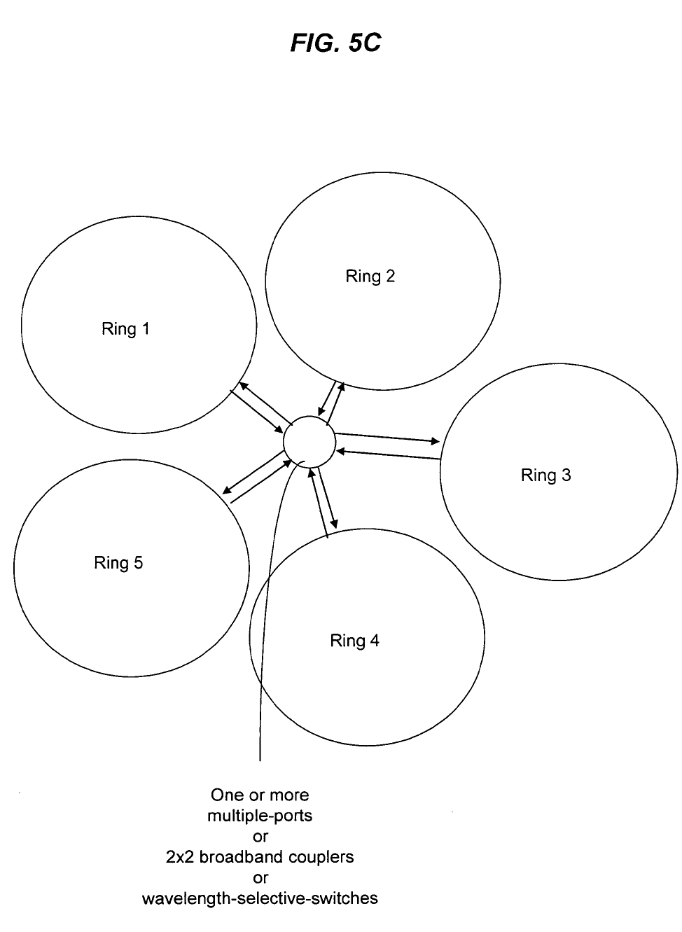

Each ring network shown in FIGS. 1, 2 and 3 may be interconnected with one or more other ring networks by using nodes configured in any one of the three node designs in FIGS. 1, 2 and 3. FIG. 5A shows an interconnecting junction node design that uses four 2×2 broadband couplers to allow all channels in one dual-fiber ring network to be coupled to another dual-fiber ring network and vice versa. Each broadband coupler is designed to couple light carried by both ring networks. The junction node can be used to add a new signal to either or both interconnected ring networks and to drop a signal from either or both interconnected ring networks.

FIG. 5B shows a junction node that can interconnect three or more dual-fiber ring networks together by using broadband couplers. In the illustrated example, two 4×2 couplers and eight 2×1 couplers are used to interconnect four dual-fiber ring networks. The same configuration with two Nx2 couplers and 2N 2×1 couplers may be used to interconnect N dual-fiber ring networks together. Notably, such a junction node can also provide add/drop functions as illustrated.

FIG. 5C shows another implementation of interconnecting multiple rings by using one or more broadband couplers or wavelength-selective switches (WSS's). Different broadband couplers shown in FIGS. 5A and 5B, the use of WSS for interconnecting rings can be configured to keep intra-ring wavelengths from going into other rings, and to allow only inter-ring wavelengths to traverse from one ring through WSS's to another ring. In addition, in FIG. 5C, if the lengths of the interconnecting optical cables to the interconnecting couplers/WSS's are short, the junction nodes at each ring are co-located. Otherwise, they are not co-located.

The above node designs, optical protection switching and junction nodes may be used to construct two or more interconnected ring networks from a given set of network nodes to provide fast optical protection switching and to reduce the down time of the communications when there is one or more communication failures.

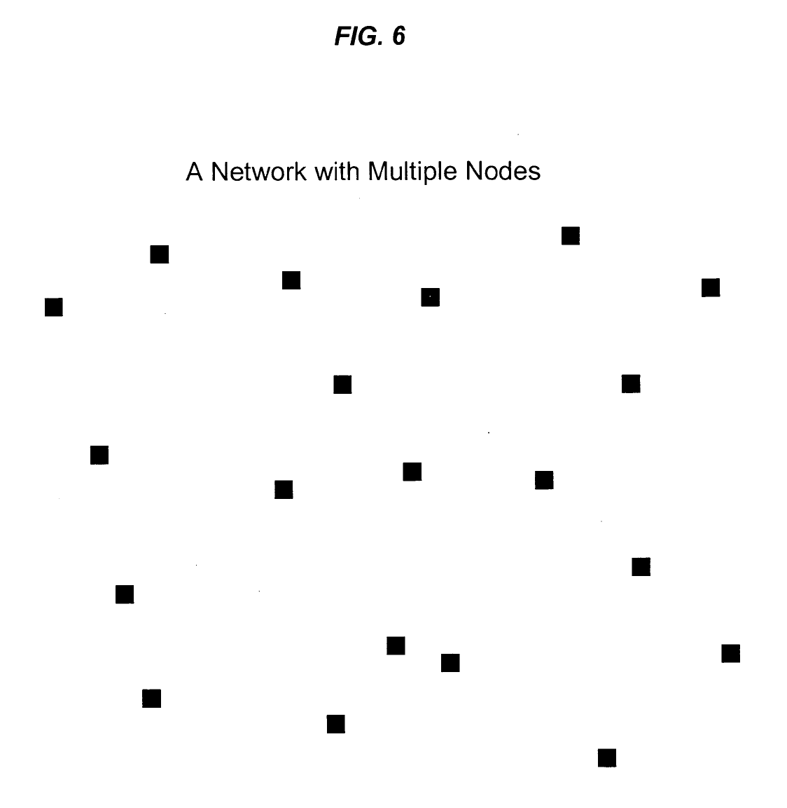

FIG. 6 illustrates a given set of communication nodes at different locations in a given service area, e.g., multiple cities or a large campus with many facilities. The locations of these communication nodes are dictated by the communication needs of the service area. The issue is how to design a communication network to link these nodes together to provide robust and efficient communications in this service area. Different network design approaches may be used for any given service area.

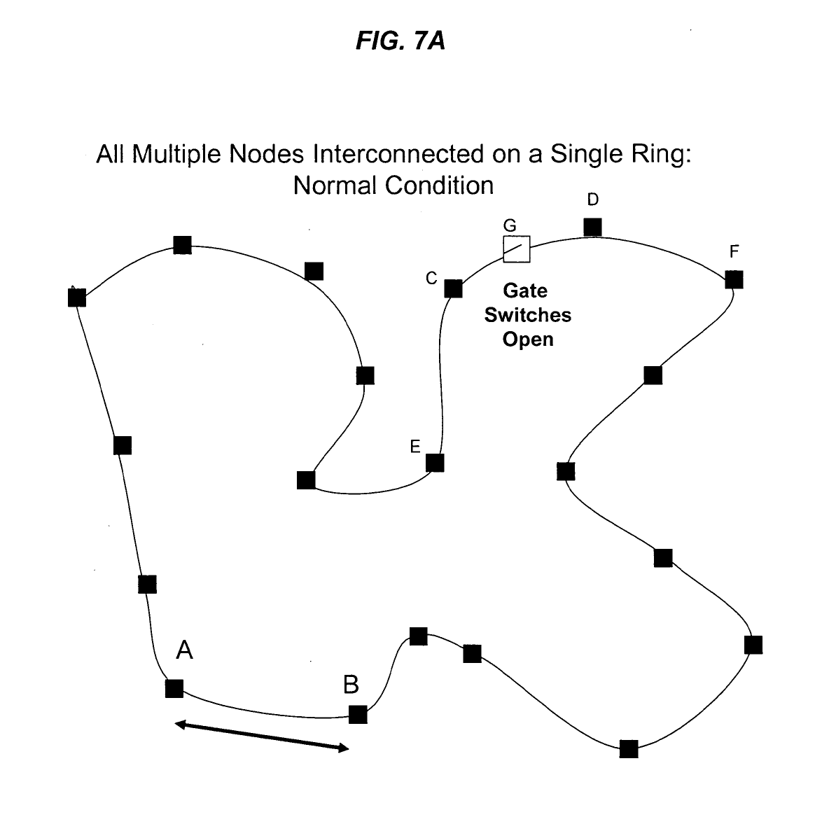

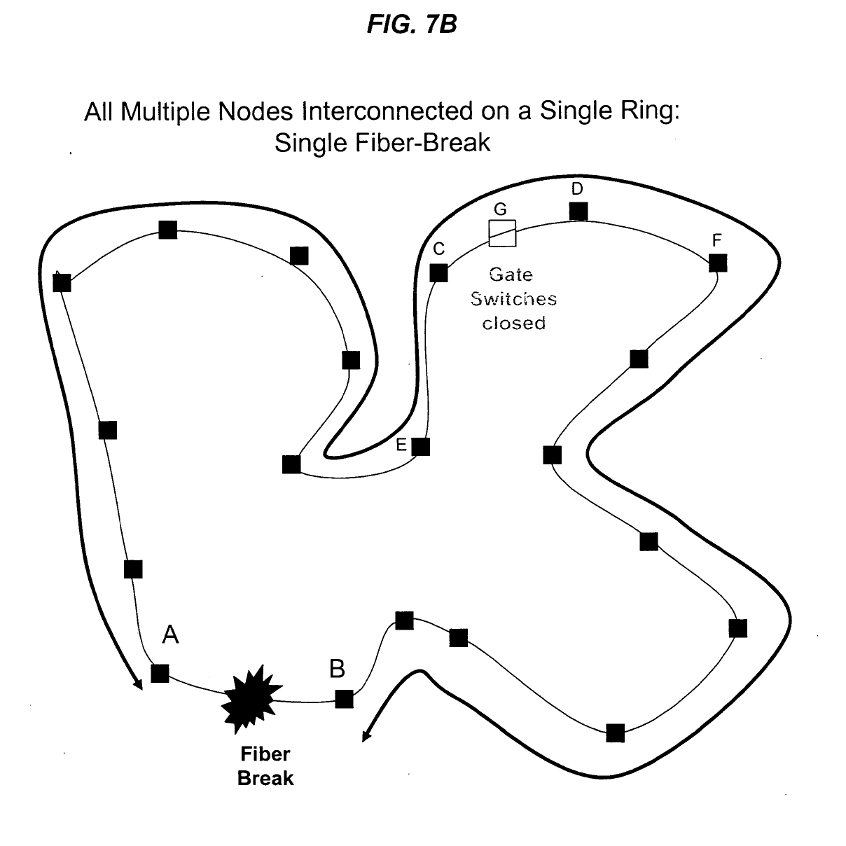

FIG. 7A illustrates a single ring approach where all the nodes in the service area shown in FIG. 6 are connected to form a single dual-fiber ring where the two fibers carry the same communication signals in two opposite directions. Like in FIGS. 8 and 9, FIG. 7A shows only one of the two fibers. One of the nodes has two optical switches that are respectively connected in the two fibers of the ring. Under the normal operating conditions where there is no optical failure in the ring, the two switches are open to create a single optical break point in each of the two fibers. This node with two open switches under the normal operating condition is referred to as a gate node and is labeled as the node G in FIG. 7A. In alternative implementations, the two optical switches for the two fibers may be located at different locations and in two different nodes where the fiber span between the two optical switches at two different locations is called a fiber protection span. The operations described blow with respect to the gate node “G” is applicable by replacing the gate node “G” by the fiber protection span.

Notably, two communicating nodes in this single ring network can communicate with each other via two alternative, different routes. For most nodes in the single ring, the two alternative routes in communicating with another node have different route lengths. The difference between the two alternative routes can be significant for a large service area with numerous communication nodes. Because the two switches in the gate node G are open where there is no optical failure in the ring, one of the two alternative routes that contains the gate node G with two open switches is not functional and thus any two nodes can only communicate via the other route that does not include the gate node G with two open switches. Hence, depending where the two communicating nodes are located relative to the gate node G with two open switches, the two communicating nodes may be forced to communicate with the longer route with a longer delay.

One example is the situation for two communication nodes that are close to but are separated by the gate node G with two open switches during the normal operation. As illustrated in FIG. 7A, any one of nodes C and E on one side of the gate node G with two open switches during the normal operation must communicate with any one of nodes D and F on the opposite side of the gate node G with two open switches during the normal operation via the longer alternative route that does not include the gate node G. This transmission distance can be significant when the ring is long with many nodes in the service area and thus may compromise the transmission signal quality of the service to the nodes such as E, C, D and F close to the gate node G. Interestingly, for these nodes close to and on the opposite sides of the gate note G, the shorter alternative route becomes available only when the gate node G closes the switches when there is a failure in the single ring.

For nodes that are far away from the gate node G, they communicate with each other via the short route without going through the gate node G under normal operating condition and via the long route by going through the gate node G where there is a failure between two communicating nodes. In addition, two immediate adjacent nodes right next to each other regardless where they are relative to the gate node G, such as nodes A and B as illustrated, they communicate via the short route which is the fiber link that directly connects the nodes A and B without any node in between under the normal operating condition. Hence, the time delay in the short route is at the minimum. When an optical failure, such as a fiber cut, occurs in the short route between the nodes A and B, the switches in the gate node G close to force the nodes A and B to communicate via the long route by going through the gate node G which has the longest time delay.

FIG. 7B illustrates this situation. Assuming the ring circumference is D in length, the maximum delay between any two nodes under the normal condition or fiber break condition is D. Therefore, the single ring design for a large service area with numerous nodes in FIG. 7A can suffer signal degradation due to long transmission distance and a significant delay for communications between certain nodes when the protection switching at a gate node G is not used and when the protection switching at the gate node G is in use in case of an optical failure. Such signal degradation and communication delay for certain nodes may be unacceptable when the service area is large and the distance D is big. Therefore, it is desirable to design the protection switching in a way that reduces the transmission distances in certain applications.

One approach to mitigating the delay and signal degradation associated with the single ring design in FIG. 7A is to divide the nodes in the given service area in FIG. 6 into two or more groups respectively located in two or more different regions where the nodes in each group are close to each other and to construct two or more interconnected smaller rings by using nodes in each group to form a ring. Hence, instead of having a single gate node G in the single ring design for the entire service area in FIG. 7A, the two or more smaller rings operate with their own respective gate nodes for the protection switching to reduce the average transmission distance and delay between any two communicating nodes in the service area. The smaller rings may be designed to have ring lengths that are equal or close to one another if possible. As an example, if the single ring for the service area in FIG. 7A has a ring length of D, N smaller rings may be designed for the same service area with each ring length being about D/N. When any two smaller rings are interconnected directly, then two communicating nodes in two separate smaller rings can communicate to each other with a delay less than a maximum delay of D/N when there is no optical failure and a maximum delay of 3D/(2N) where N is an integer not less than 2.

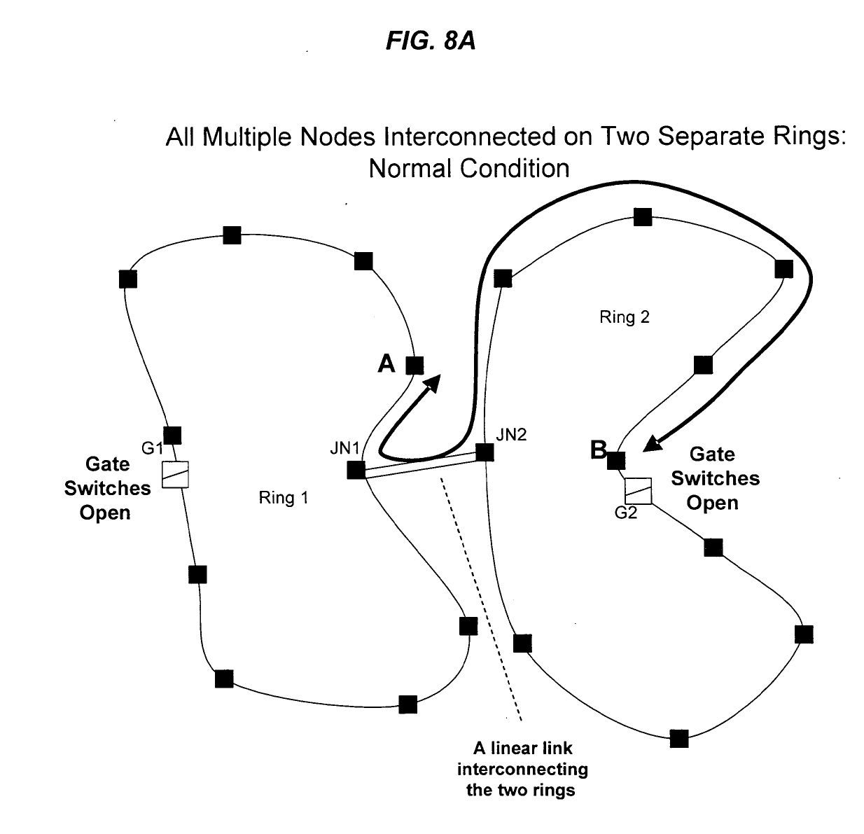

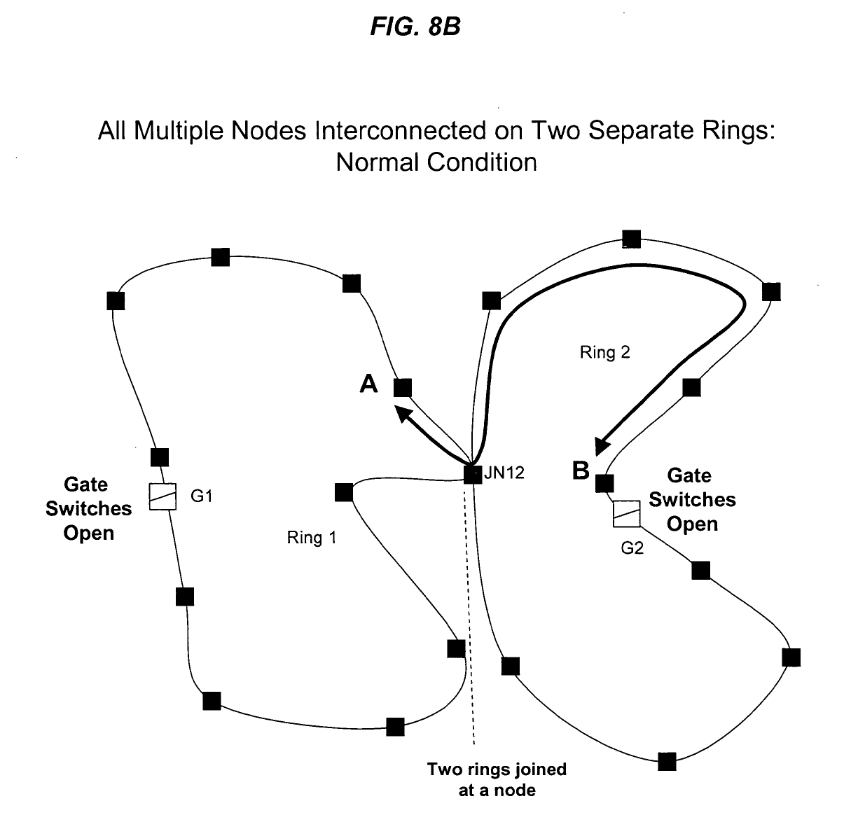

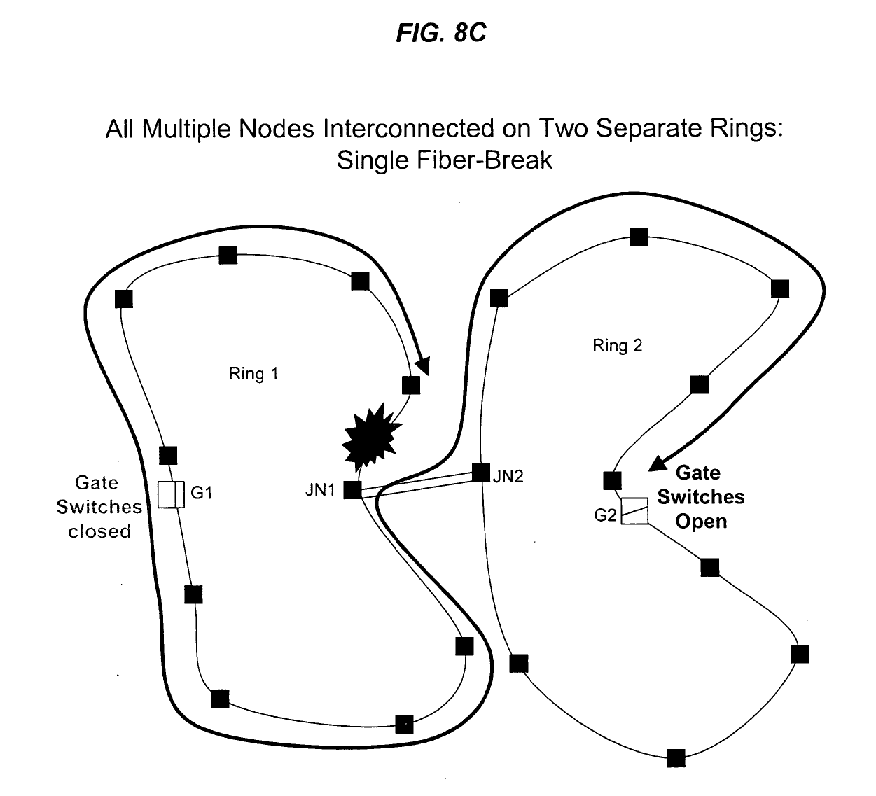

FIG. 8A illustrates one exemplary design under this approach where the nodes in the service area in FIG. 6 are connected by two interconnected rings 1 and 2 (N=2) with their own respective gate nodes G1 and G2 for protection switching. The rings 1 and 2 are interconnected by two junction nodes JN1 in the ring 1 and JN2 in the ring 2. A linear link is used to interconnect the nodes JN1 and JN2 and allows for all traffic to flow between the two rings 1 and 2. The gate node G1 in the ring 1 may be designed to be as far away from the junction node JN1 as possible and similarly the gate node G2 in the ring 2 may be designed to be as far away from the junction node JN2 as possible to minimize the transmission distance and delay between any two communicating nodes in the entire service area. Therefore, the gate node in each smaller ring should be located at or close to a middle location whose distances from the junction node via two alternative routes in that ring are equal.

FIG. 8B shows one exemplary design under this approach where the nodes in the service area in FIG. 6 are connected by two rings 1 and 2 (N=2) with their own respective gate nodes G1 and G2 for protection switching and the two rings 1 and 2 are interconnected by a common junction node JN12 shared by both rings.

FIG. 8C shows the operating status of the interconnected rings 1 and 2 in FIG. 8A when there is a failure in ring 1. If the two rings 1 and 2 have a ring circumference of D/2, the maximum transmission distance between any two nodes is about D/4+D/4=D/2 under the normal condition (FIG. 8A) and is D/2+D/4=3D/4 when there is a fiber break (FIG. 8C).

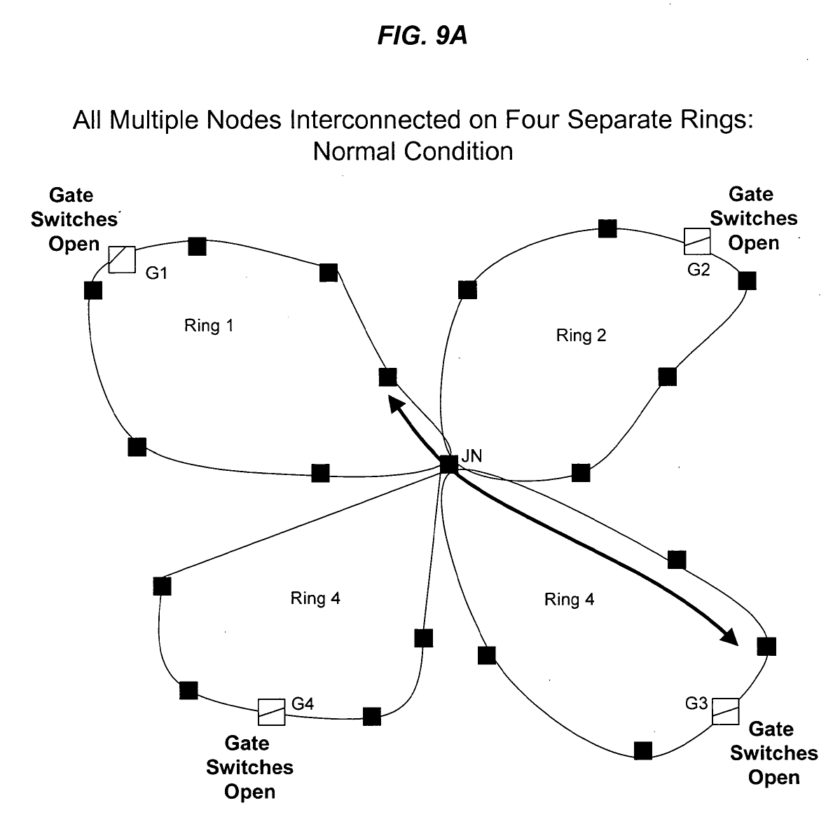

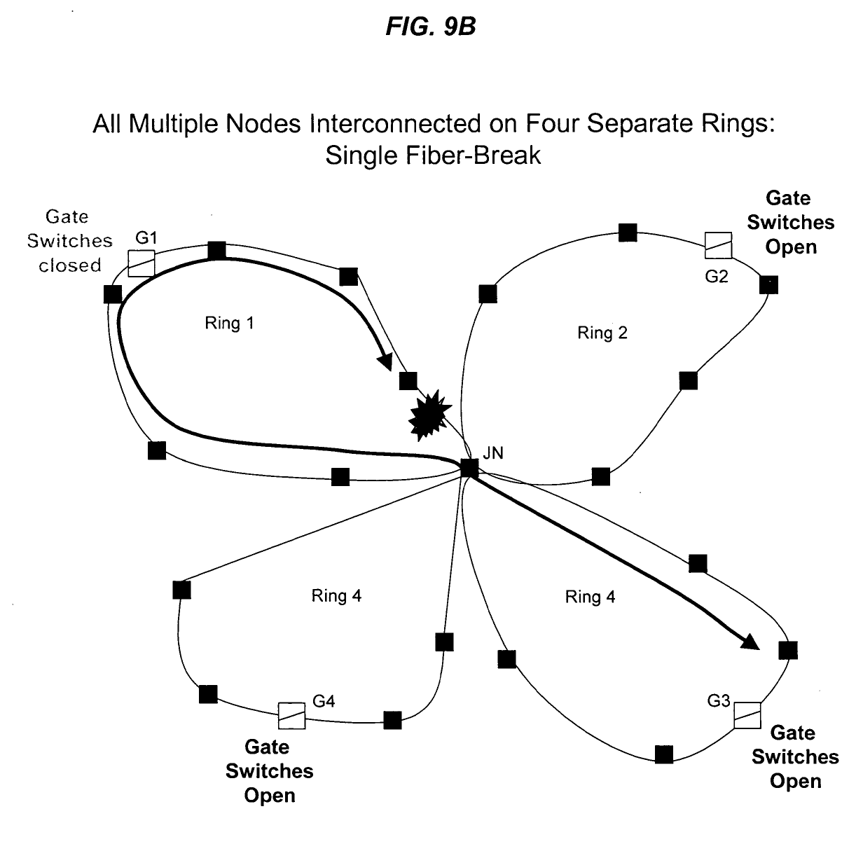

As the number of rings, N, for the same service area with a fixed set of nodes increases, the delay reduces with N. FIGS. 9A and 9B show one exemplary design under this approach where the nodes in the service area in FIG. 6 are connected by four interconnected rings 1, 2, 3 and 4 (N=4) via a common node JN. The four rings have their own respective gate nodes G1, G2, G3 and G4 for protection switching and each gate node is located at or near the middle point in each ring.

TABLE I summarizes the delays in various multiple interconnected ring configurations for the same service area.

TABLE I

| | Single Ring | Two Rings | Four Rings | N Rings |
|---|---|---|---|---|
| | Average ring | Average ring | Average ring | Average ring |
| | circumference = D | circumference = D/2 | circumference = D/4 | circumference = D/N |
| Normal Condition: | D | D/2 | D/4 | D/N |
| Max transmission | | | | |
| distance between | | | | |
| any two nodes | | | | |
| Fiber Break | D | 3/4 D | 3/8 D | (3/2N) D |
| Condition: | | | | |
| Max transmission | | | | |
| distance between | | | | |
| any two nodes | | | | |

In addition to reduction in communication delay, the above multiple interconnected ring design can also improve the optical signal-to-noise ratio (OSNR) due to the reduced transmission distance and the reduced number of nodes in the signal path.

In operation, to maintain a shorter transmission distances between any two nodes in the network, under normal and fiber-break conditions, it is important to revert a gate switch back to “open” after a fiber break is fixed. When there is a fiber break in one of the smaller rings, the gate switch in that particular ring with the fiber break is closed, while all other gate switches in other smaller rings remain open. Hence, as illustrated in examples in FIGS. 8A-9B, the gate switches in G1, or G2 that are located at approximately equal distances from two possible routes to a junction node within a given ring in an interconnected ring system are controlled to revert to their default open positions under normal operation. As an example shown in FIG. 4A, when a fiber break occurs between nodes 3 and 4, the nodes 3 and 4 set their respective VOAs to their respective maximum attenuations to switch off the optical paths in both directions in the two fibers while the gate switches in the nodes 1 and 2 are closed. When the fiber break is repaired and restored, the two gates switches are reverted to open again and the nodes 3 and 4 set their respective VOAs to the minimum attenuations.

The control and intelligence for the switching protection in interconnected ring networks may be implemented in a junction node, a gate node in each ring, or other node. The OSC channels are used to carry the control and detection information for the protection switching and the reversion to the default state for each gate switch in each fiber ring.

The rings in FIGS. 8A-9B may be dual-fiber rings and the gate nodes G1 and G2 each can include two gate switches that are connected to two different fibers, respectively. As described above, the two gate switches may be at different nodes in other implementations.

The following sections describe optical ring networks designed with variable optical attenuators (VOAs) inside optical network nodes in each ring to provide control over signal strengths such as adjusting the inter-span optical loss between networks nodes and to operate as part of the protection switching mechanism of the ring network. Such ring networks may be used in the interconnected ring networks described above. Each VOA is configured to have a maximum optical attenuation and a minimum optical attenuation where the maximum optical attenuation is set to suppress the optical transmission such that the VOA essentially operates like an optical switch in an open position. Under the normal operation, each VOA operates as an optical attenuator below the maximum attenuation to adjust the signal amplitude passing through the VOA. One or more optical supervision channels (OSCs) are implemented in such ring networks to manage and operate the protection switching mechanism according to predetermined control algorithms for maintaining a single break point or a single break span in each ring path. Such control algorithms may be specific to the configurations of the ring networks and may vary from one ring network to another.

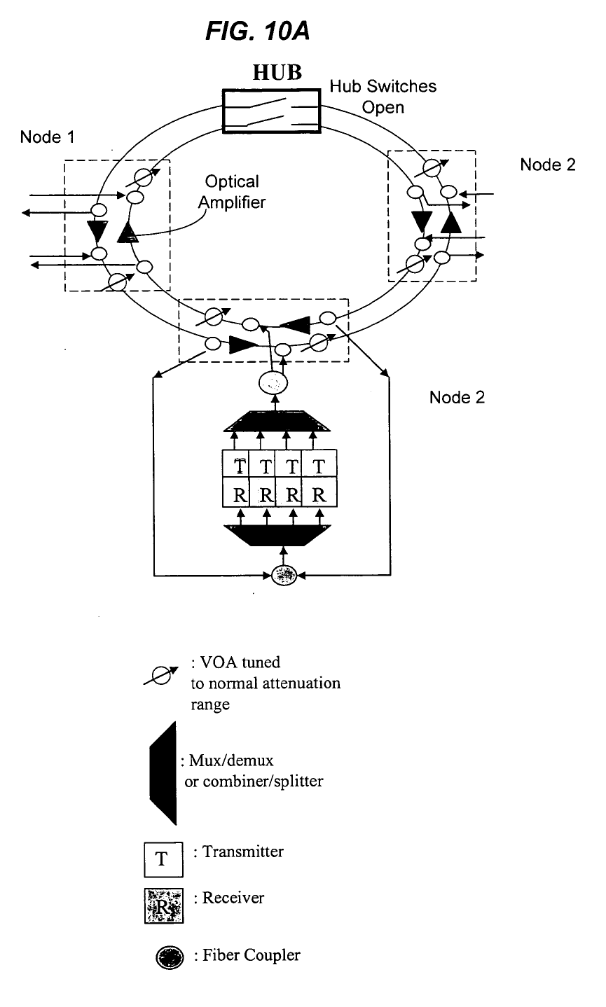

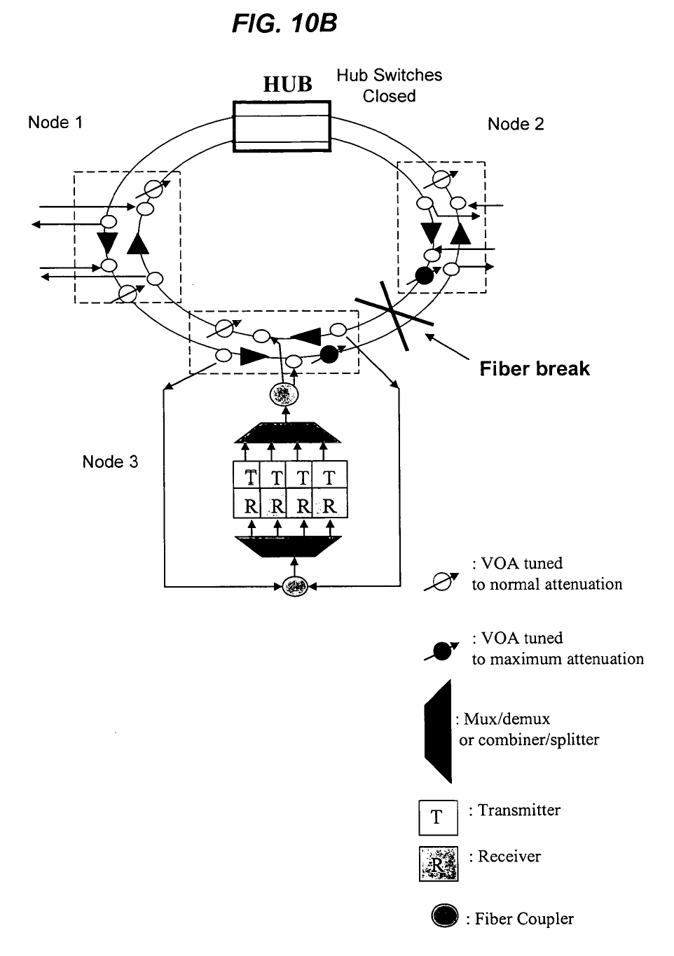

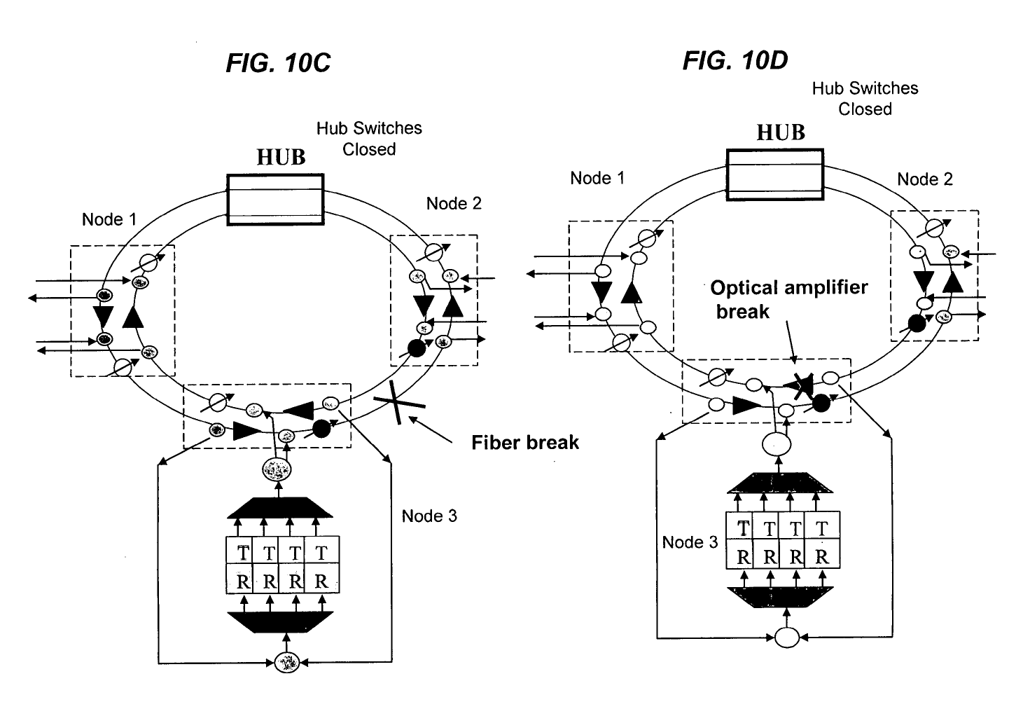

FIGS. 10A, 10B, 100 and 10D show the design and operation of an exemplary ring network with dual fiber rings carrying optical signals in two opposite directions, respectively. The same optical signals are carried in the two fiber rings.

Certain aspects of the general optical layout of this ring network are similar to the dual-fiber ring network shown in FIG. 6 of the U.S. Patent Publication No. US 2003/0025961. For example, a hub is provided in the ring with a hub optical switch in each fiber ring and each node is designed to provide optical transmission to both fiber rings and to broadcast to other nodes and receive optical signals from both fiber rings. In addition, the optical reception in each node can be selective to receive only desired channels so that the ring network can operate as a broadcast and select network.

The ring network in FIGS. 10A-10D further provide two separate VOAs in each regular node that are respectively coupled to two fiber rings to (1) provide control over signal strengths such as adjusting the launched optical power to avoid optical nonlinearity or the inter-span optical loss between networks nodes, (2) operate as part of the protection switching mechanism of the ring network, and (3) automatic reversion after the fiber break is repaired.

In FIG. 10A, only the two hub optical switches are shown and other components are omitted. Three regular nodes 1, 2 and 3 are illustrated as examples where the transmitters and receivers for different channels are shown in the node 3 but other regular nodes are similarly constructed. In each regular node, the in-line components include a drop fiber coupler, an add fiber coupler, an optical amplifier, and a VOA in each fiber. In the illustrated example, the VOA in each node is located at the output side of the node. Alternatively, the VOA may be located at a different location in each node.

Under the normal operation as shown in FIG. 10A where there is no optical failure in the dual-fiber ring, the hub switch in each fiber is open to create an optical break point in each of two fiber rings and all node VOAs operate at their desired optical attenuation settings to transmit signals and to provide proper adjustments to the transmitted signal strengths. When an optical failure occurs, either in a node (FIG. 1D) or in a fiber (FIG. 10B, 10C), the ring network detects the location of the optical failure and activates the protection switching mechanisms to control the hub switch and the selected node VOAs via communication through the OSC signals.

In the illustrated example in FIG. 10B where both fibers are cut between two adjacent nodes 3 and 2, both hub switches in the hub are closed immediately (e.g., within 50 ms) upon detection of the fiber cut through the OSC notification as part of the protection switching mechanism. The node VOAs in the two adjacent nodes 3 and 2 which surround the fiber cut are set to their maximum attenuations to practically cut off the transmission via the two nodes and thus to break the span between nodes 3 and 2. As a result, no traffic can be sent to or received from the broken span between the nodes 3 and 2. Before and when this fiber cut is being repaired, the hub switches remain closed and the two node VOAs in the two adjacent nodes 3 and 2 remain at their maximum attenuations to prevent circulation of light. Next, after the fiber cut is repaired, both hub switches are opened again while immediately after that, the two node VOAs in nodes 3 and 2 are reset to their proper attenuations so that the two nodes 3 and 2 resume their normal traffic transmissions.

In the illustrated example in FIG. 10C where one fiber for the counter clockwise fiber ring is cut between two adjacent nodes 3 and 2, both hub switches are closed within 50 ms after the fiber cut through the notification via OSC communications. Note that even though there is only a single fiber cut, still both hub switches are closed in this particular implementation of the protection switching mechanism. The node VOAs in the two adjacent nodes 3 and 2 which surround the fiber cut are set to their maximum attenuations to break the span, so that no traffic can be sent to or received from the broken span. When this fiber cut is being repaired, the hub switches remain closed and the two node VOAs are at the two adjacent nodes 3 and 2 remain at their maximum attenuations to prevent circulation of light. Next, after the fiber cut is repaired, both hub switches are opened again while immediately after that (within 50 ms) the two node VOAs are reset to their proper attenuations to resume the traffic transmissions of the two nodes 3 and 2.

FIG. 10D illustrates a condition where an amplifier in the counter clock wise fiber in the node 1 fails. The protection switching operation is similar to that in FIG. 10C where a single fiber fails.

The protection switching operations shown in the examples in FIGS. 10C and 10D are to maintain a broken point on the fiber ring via the two hub switches at the hub under the normal operating condition. Instead of a single break point at the hub, the protection switching mechanism for the dual-fiber ring network in FIG. 10A can also be configured to maintain a broken span or a protection span in the dual-fiber ring. In other words, the two hub switches located in a single node (the hub) can be replaced by two optical switches or VOAs that are respectively coupled in the two different fibers and are located in two different nodes surrounding a broken span. This broken span may be include either a segment of the transmission fiber or the combination of a segment of the transmission fiber and one or more optical amplifiers.

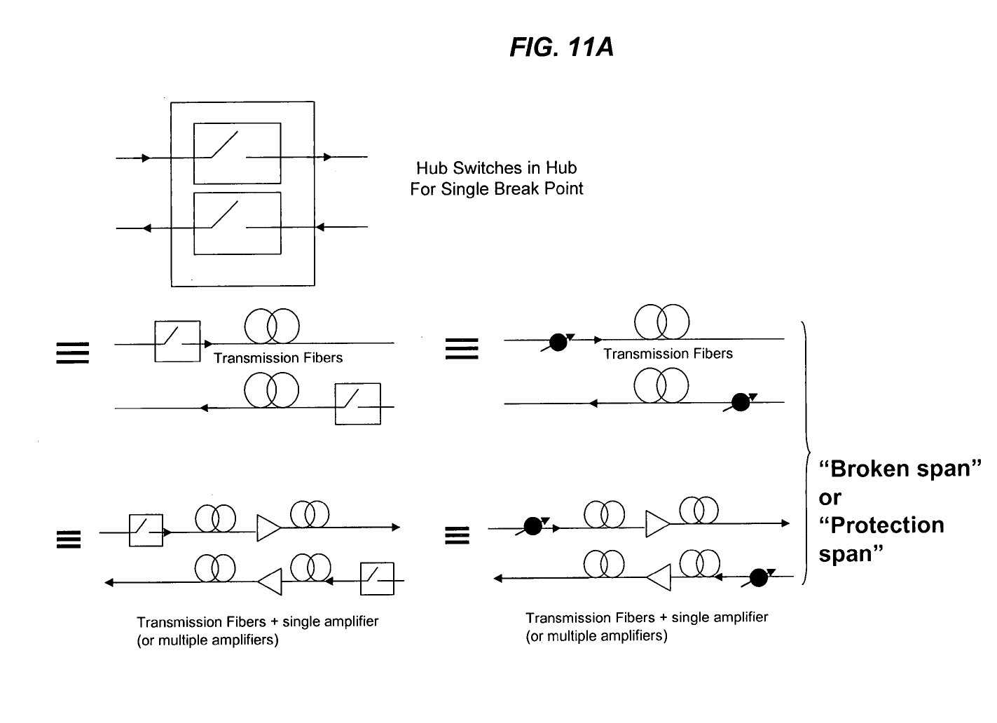

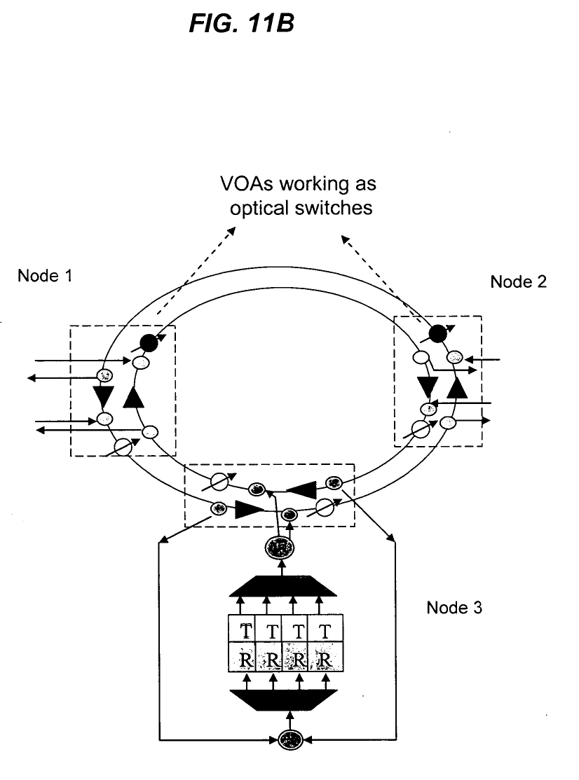

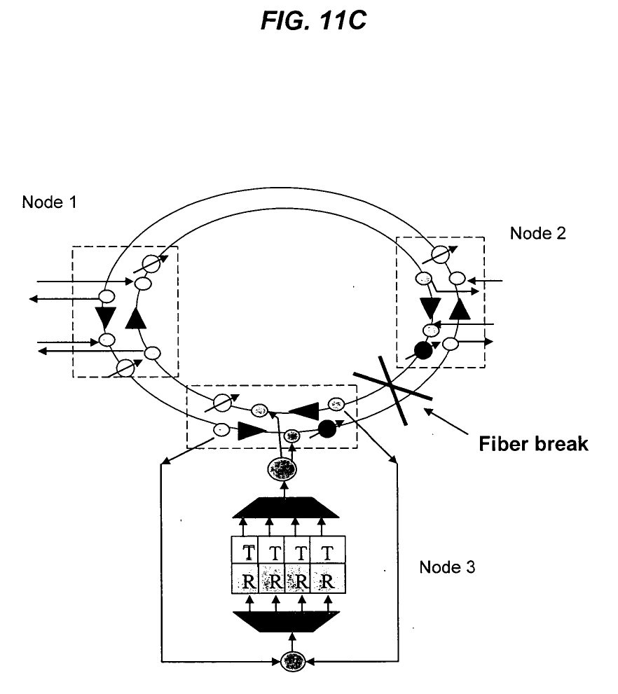

FIG. 11A illustrates implementations of a broken span by two switches or two VOAs in two different nodes in a dual-fiber ring. In some implementations, the special hub node may be replaced with a regular node having two VOAs so that all nodes in the ring are identically constructed and any one node may be used to provide the single break point or two adjacent nodes may be used to provide the broken span or protection span. This uniform node structure throughout the ring allows for implementing the protection switching operations at segment within the ring and provides a distributed protection switching.

FIGS. 11B and 11C show two examples of the protection switching in a dual-fiber ring where all nodes are regular nodes without a special hub node. In FIG. 11B, the ring has no optical failure and the nodes 1 and 2 are operated to provide a single optical break point in each of the two fibers so that a protection span is created between the nodes 1 and 2. In FIG. 11C, both fibers of the ring are broken between the nodes 3 and 2, nodes 3 and 2 surrounding the fiber break are operated to create a protection span between nodes 3 and 2.

Notably, the initial protection span between nodes 1 and 2 under the normal operating condition in FIG. 11B has been replaced by the new protection span between the nodes 3 and 2 in FIG. 11C due to the fiber break between the nodes 3 and 2. In an effect, the initial protection span between nodes 1 and 2 has been dynamically changed to the current protection span between nodes 3 and 2. As the operating condition changes, the protection span changes accordingly. This illustrates the temporal dynamic nature and the spatially distributed nature of the protection switching mechanism in ring networks in FIGS. 11B and 11C where all nodes are identically constructed.

Another notable feature of the above protection switching mechanism in the ring network in FIGS. 11B and 11C is that a particular protection span invoked in response to a particular optical failure such as a fiber cut or a failed optical amplifier do not need to change after the optical failure is corrected. This feature is different from the protection switching mechanism in fiber rings with a fixed hub which has hub switches as illustrated in FIGS. 10A-10D. Referring to FIGS. 10B and 10C, after the fiber cut between nodes 3 and 2 is repaired, the VOAs in the nodes 3 and 2 are changed from their maximum attenuations for blocking optical transmission to lower attenuations to allow for optical transmission and the hub switches are opened to create a break point in each of the two fibers. In the ring network in FIG. 11C, after the fiber cut is repaired, the nodes 3 and 2 can remain the protection span between them for the subsequent normal operation of the ring until the next optical failure occurs. Hence, protection switching mechanism in the ring network in FIGS. 11B and 11C is simpler in its operation.

The above protection switching mechanisms based hub switching and dynamic and distributed switching without hub switching may also be applied in ring networks with a single fiber. Nodes in such single-fiber ring networks are designed to allow each node to send out an optical signal to two counter propagating directions in the ring and to receive a signal from both directions in the ring.

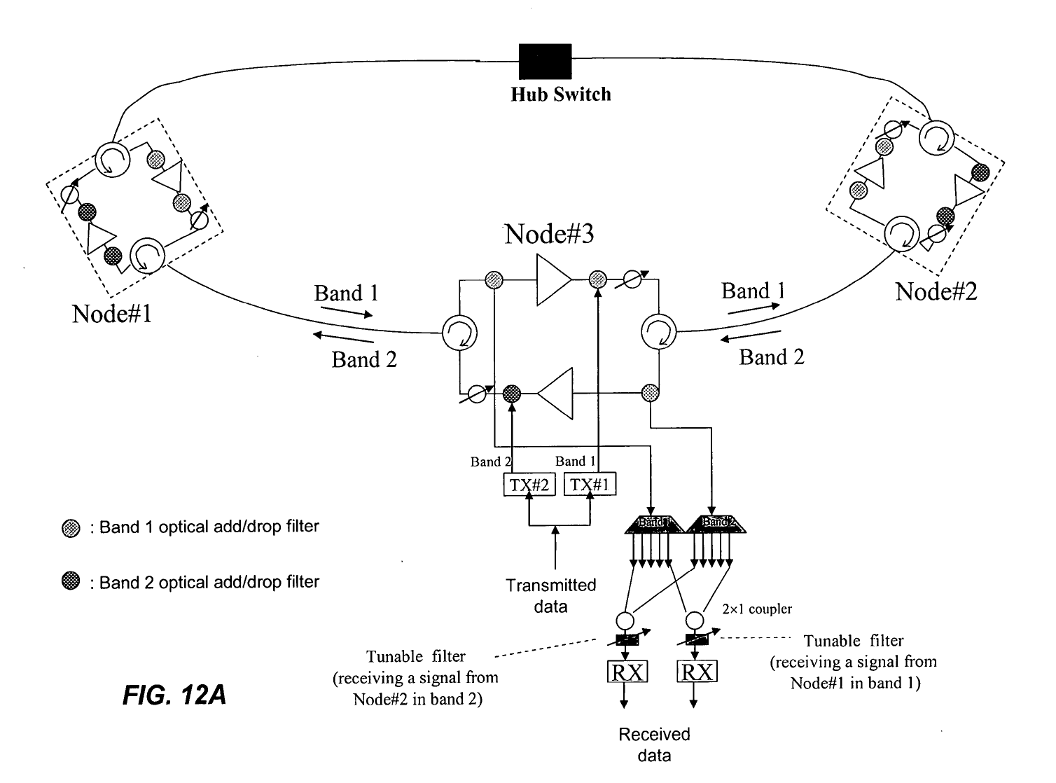

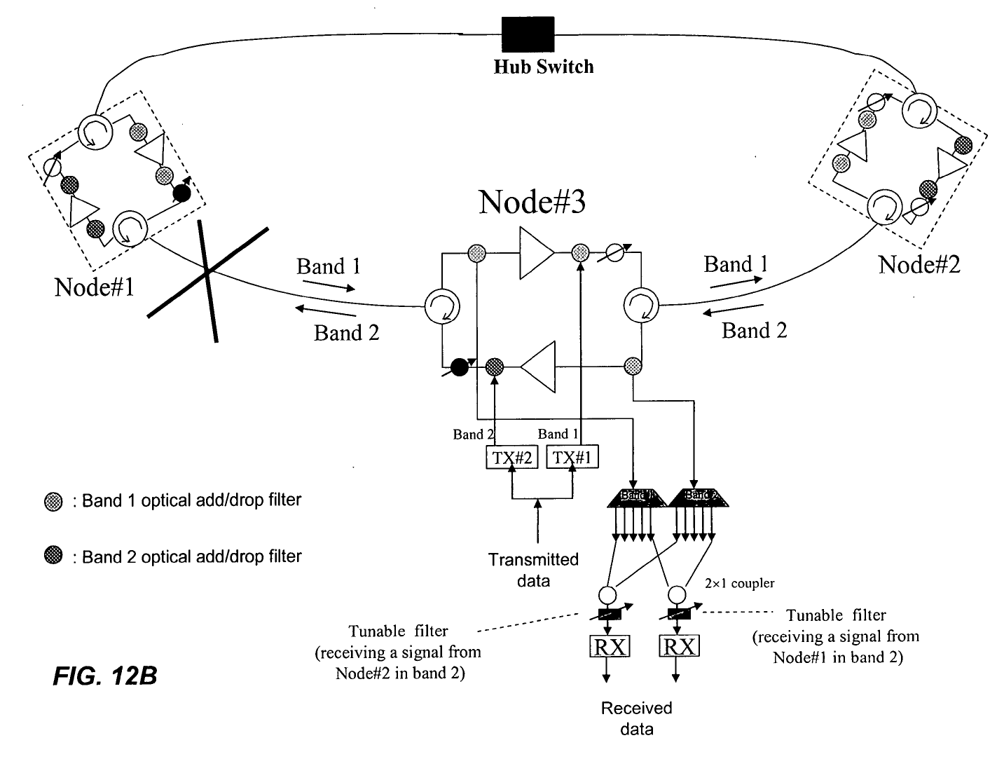

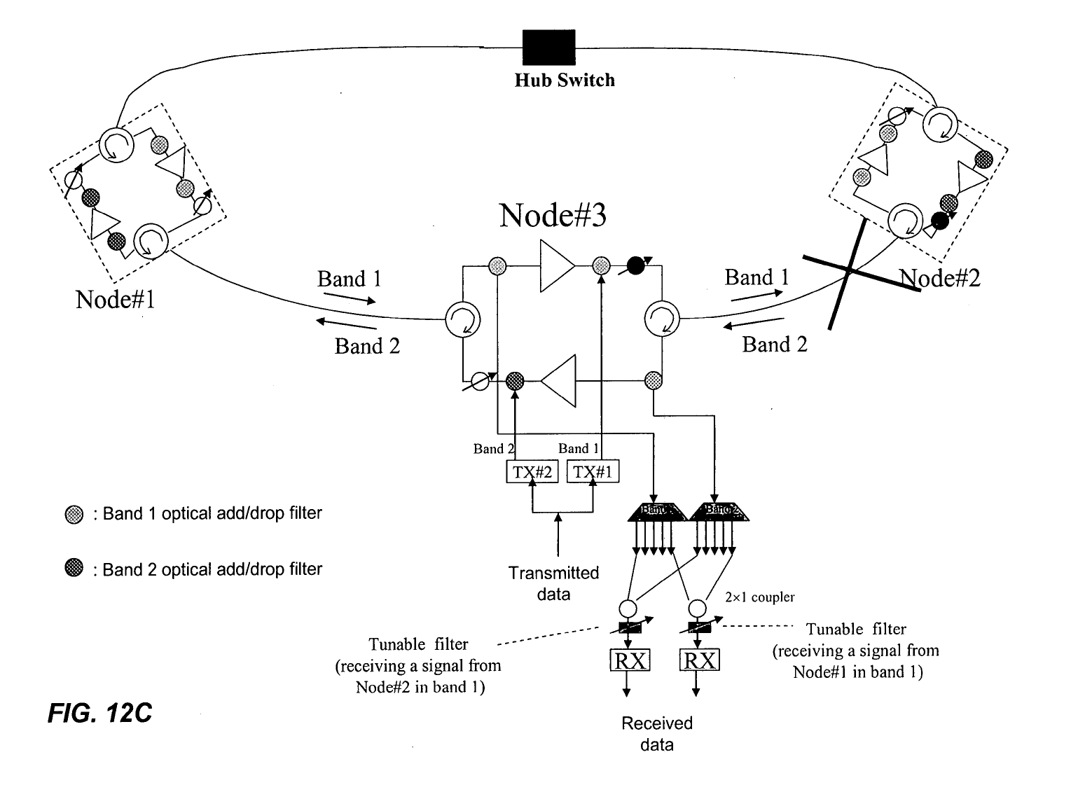

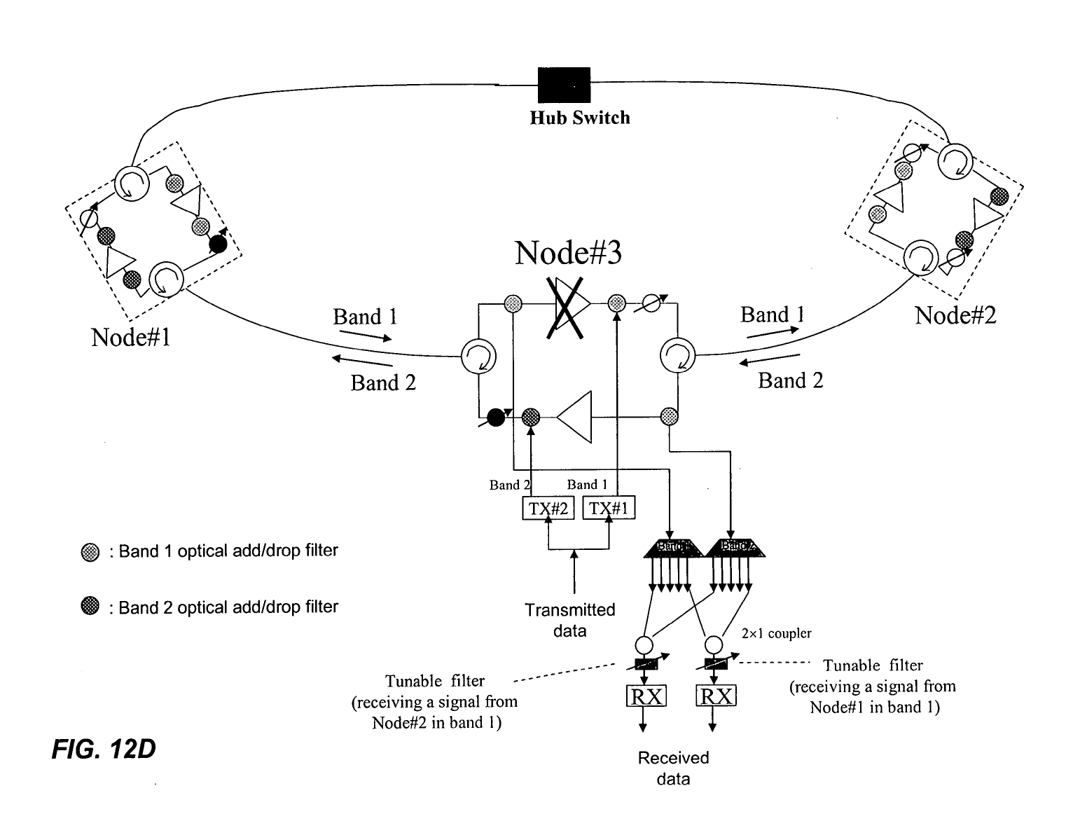

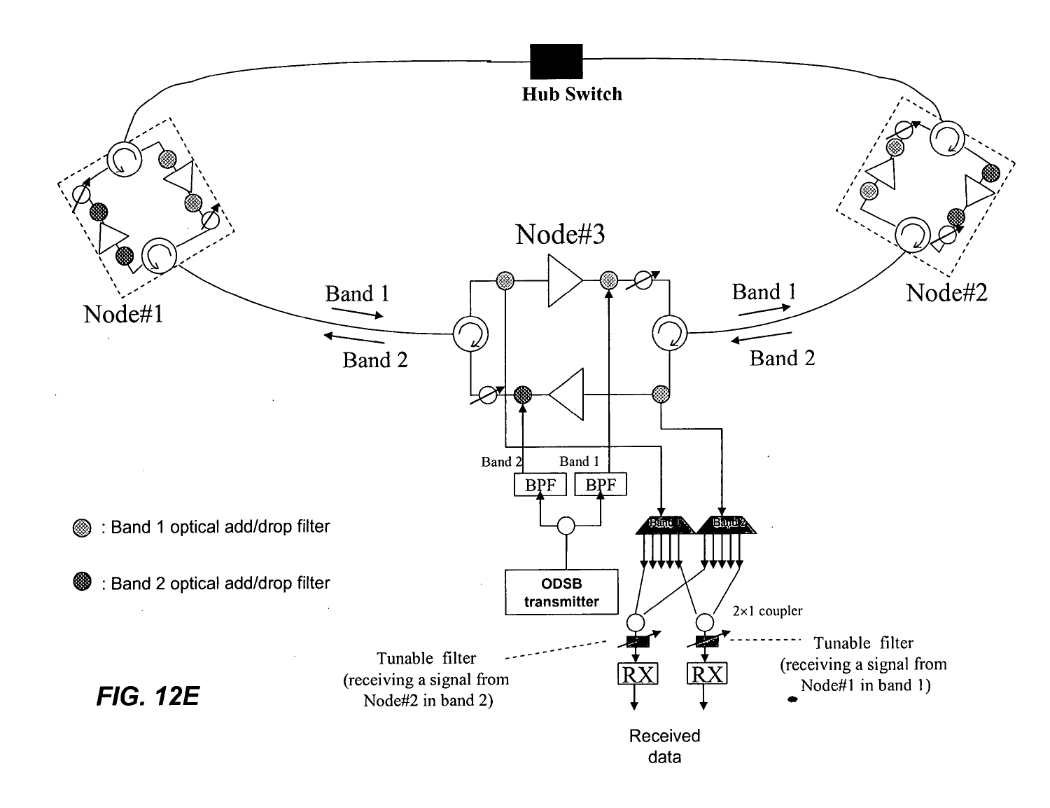

FIGS. 12A-12D show the design and operation of an exemplary ring network with a single fiber ring to carry two counter propagating optical traffics at two different wavelength bands (band 1 and band 2) for one hub and multiple nodes coupled to the ring. The hub includes a hub switch as part of the protection switching mechanism. The hub switch may be replaced by a VOA with a large attenuation to emulate an optical switch, and each of the nodes includes a node VOA. The hub switch and the node VOAs form part of the protection switching mechanism. The hub optical switch has an open position to cut off the optical transmission through the hub and a close position to allow for optical transmission. Each node is constructed to support optical signals in two opposite directions based on the design described with respect to FIGS. 9A through 9E in the U.S. Patent Publication No. US 2003/0025961.

Referring to the example shown in the node 3 in FIG. 12A, each node includes first and second separate optical paths. The first optical path is to receive light from the fiber ring in the first propagation direction only and includes a first optical amplifier to amplify light, a first drop coupler to drop light from the first optical path, and a first add coupler to add light to the first optical path. The second optical path is to receive light from the fiber ring in the second propagation direction only and includes a second optical amplifier to amplify light, a second drop coupler to drop light from the second optical path, and a second add coupler to add light to the second optical path. Each node uses a first optical port, such as an optical circulator as shown, to couple a first end of the first optical path and a first end of the second optical path to the fiber ring and to direct light in the first propagation direction in the fiber ring to the first optical path and light in the second propagation direction in the second optical path into the fiber ring. On the opposite side of the node, a second optical port such as another optical circulator is used to couple a second end of the first optical path and a second end of the second optical path to the fiber ring and to direct light in the first propagation direction in the first optical path to the fiber ring and light in the second propagation direction in the fiber ring into the second optical path.

FIG. 12A further shows a signal add module with two transmitters TX1 and TX2 to produce a first add signal at a first wavelength (band 1) carrying data and a second add signal at a second wavelength (band 2) carrying the same data and couple the first add signal to the first optical path via the first add coupler and the second add signal to the second optical path via the second add coupler. Note that both transmitters send the information toward different directions for the purpose of protecting ring fiber break. A signal drop module is also provided to receive a first drop signal from the first optical path via the first drop coupler and a second drop signal from the second optical path via the second drop coupler. Optical receivers (RXs) are used to receive different optical channels to extract data. An optical demultiplexer (or an optical coupler) for each wavelength band may be used to separate different optical channels within each band. A 2×1 optical coupler is then used to receive signals from both demultiplexers for bands 1 and 2 to receive signals from both bands 1 and 2 and a tunable optical filter is then used to select a channel from the output of the 2×1 optical coupler for the optical to the corresponding channel optical receiver. Only one of the first and second drop signals is selected by the tunable optical filter for the optical receiver (RX).

Each of the two optical paths in each node includes a node VOA, that is, two separate node VOAs are respectively coupled to the first and second optical paths in each node. Each node VOA is to (1) provide control over signal strengths such as adjusting the inter-span optical loss between networks nodes and (2) operate as part of the protection switching mechanism of the ring network. Each of the two node VOAs controls the degree of the optical transmission of the corresponding node and has a maximum optical attenuation and a minimum optical attenuation. The maximum optical attenuation is set to suppress the optical transmission such that the VOA essentially operates like an optical switch in an open position. Under the normal operation, each node VOA operates as an optical attenuator between the maximum and the minimum attenuations to adjust the signal amplitude going out of or coming into the node and the hub switch is in the open position to provide a single optical break point in the ring. This normal network status is illustrated in FIG. 12A.

When an optical failure in the ring network in FIG. 12A occurs, two node VOAs in two nodes adjacent to the location of the optical failure may be controlled to operate at the maximum attenuation to essentially stop the optical signal transmission toward the fiber break point while the hub switch is closed. FIGS. 12B-12D illustrate three examples. After the optical failure is corrected, the hub switch is open again.

FIGS. 12B and 12C show that an optical failure such as a fiber cut. The ring network detects this failure and its location. Next, the failure and its location are communicated to the control unit of the network via one or more OSC signals. The control unit, which may be located in the ring network, subsequently commands the hub switch to be closed and the node VOAs in the nodes surrounding the fiber break point to operate at their maximum attenuation to shut off the transmission toward or from the fiber break. In this configuration, all nodes of the ring network remain operative. When this optical failure is corrected, e.g., the fiber cut is repaired, the hub switch is still at the closed position, the two node VOAs remain at the maximum attenuation to prevent circulation of light. Next, the hub switch is opened again while immediately after that (within 50 ms), the node VOAs at the maximum attenuation are reset to an appropriate attenuation setting and resumes its normal optical transmission. The same sequence applies if the optical failure is within a node such an optical amplifier failure as shown in FIG. 12D. Using this algorithm, all nodes remain operative during a single point of failure on the ring.

The above use of the node VOA eliminates the need for a local node optical switch. The function of each node VOA as the means for adjusting the output signals of each node is not affected by its function as part of the protection switching mechanism.

The ring network in FIGS. 12A-12D also includes an optical supervision channel mechanism which provides optical supervision channel signals at different supervision channel wavelengths in the first and second propagation directions in the fiber ring that carry information of control and management of the fiber ring and are out of the wavelength band of the optical signals. The commands carried by optical supervision channel signals are used to control the hub switch and node VOAs when there is an optical failure in the ring network.

Under normal operation shown in FIG. 12A, the hub switch is open and all node VOAs operate to control signal strengths. FIGS. 12B-12C show the operation of the protection switching mechanism when there is an optical failure such as a fiber break or cut between two adjacent nodes. Upon detection of the failure, the hub switch is open. In addition, the node VOAs surrounding the fiber cut are set to their maximum attenuations to shut off traffic transmission toward or from the fiber cut (in each optical path). A node VOA that operates at its maximum attenuation is labeled as a “darkened VOA” in FIGS. 3B-12C. After the fiber cut is repaired, the hub switch is open again and immediately after that (within 50 ms), the two darkened VOAs in the two adjacent nodes are reset back to their desired attenuations for controlling the signal strengths. This sequence of operation avoids a closed optical loop for re-circulating the light.

FIG. 3D shows the operation of the protection switching mechanism when there is an optical failure (e.g., an optical amplifier) in one of the two optical paths within a node. Upon detection of the failure, the hub switch is open, and one VOA in the failure node and the other VOA adjacent to the failure node are set to their maximum attenuations to form a broken span, as shown in FIG. 12D. Node VOAs in other nodes remain in their normal operations for controlling the signal strengths. After the optical failure is corrected, the hub switch is open again, and immediately after that (within 50 ms), two darkened VOAs in the repaired node are reset back to their desired attenuations for controlling the signal strengths. This sequence of operation avoids a closed optical loop for re-circulating the light.

FIG. 12E shows another example of a single-fiber ring network except that a single optical transmitter is used in each node to produce the optical signals in two different wavelengths bands. An optical coupler splits the output from the optical transmitter into two add signals. Two band filters (note that in this case the two bands are interleaved in the wavelength domain) are used to filter the two add signals, respectively, so that the first band filter transmits the first add signal at the first wavelength and the second band filter transmits the second add signal at the second wavelength. The operations of the hub switch and the node VOAs are identical to the operations in FIG. 12A-12D.

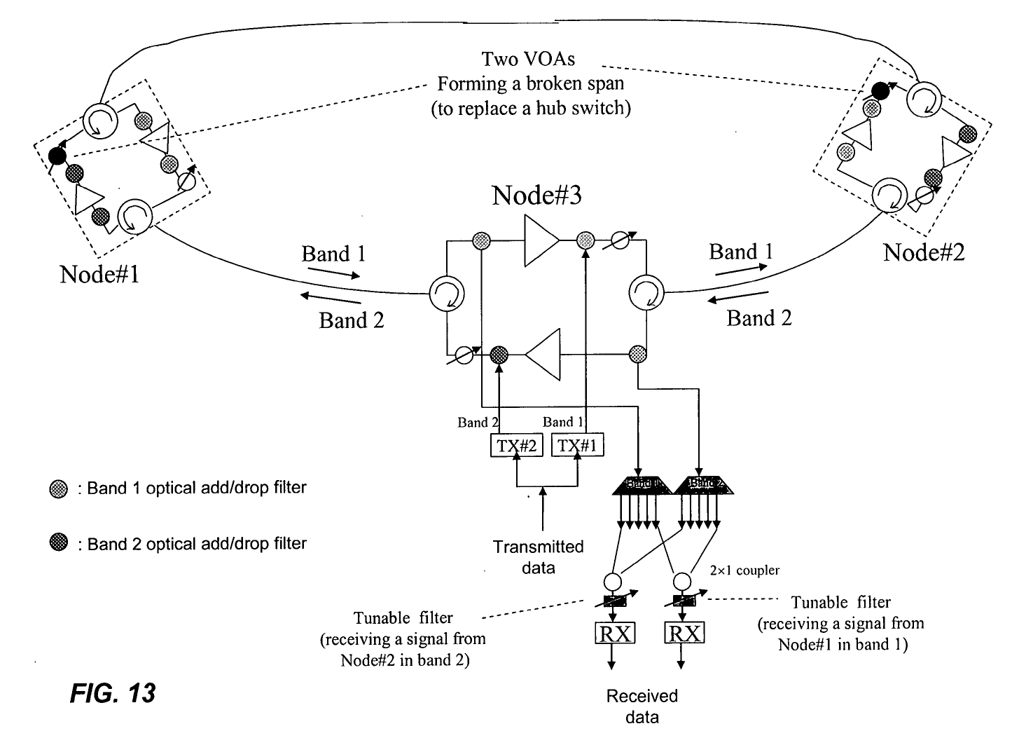

Similar to the dual-fiber ring networks described above, the hub in a single-fiber ring may be eliminated so all nodes are similarly constructed with two node VOAs. Accordingly, the protection span in FIG. 11A and further illustrated in FIGS. 11B and 11C for the dual-fiber ring networks may be applied to the single fiber rings. FIG. 13 shows one example where nodes 1 and 2 are currently used to provide a protection span. Just as in the dual-fiber rings, a protection span in FIG. 13 may be dynamically changed to any two nodes at a different location depending on the optical failure condition in the ring.

The protection span illustrated in FIG. 11A can be implemented in dual-fiber ring networks with different node designs as shown in FIGS. 1-4D. In this dual fiber ring network, the two hub switches (which can be replaced by two VOAs with large attenuations) which form a broken span are located in the so called “gate nodes” (node 1 and node 2, respectively). Other optical nodes in the ring network, such as nodes 3 and 4, are “regular” nodes where each node includes two node VOAs respectively coupled to the two fiber rings and does not have an optical switch. Each node VOA is to (1) provide control over signal strengths such as adjusting the inter-span optical loss between networks nodes and (2) operate as part of the protection switching mechanism of the ring network. In the case where the gate node switches can be replaced by VOAs, there is no fixed locations necessary for gate nodes, because every node will then have the same structure. As a result, the selection of gate nodes becomes a lot more flexible and dynamic.

Notably, the two gate nodes 1 and 2 with hub switches also include VOAs which (1) provide control over signal strengths such as adjusting the inter-span optical loss between networks nodes and (2) operate as part of the protection switching mechanism of the ring network. The gate node 1 includes a first add/drop unit, “A/D West,” that adds the OSC signal and new add signal to the counter clockwise (CCW) fiber ring (west) where the node VOA is in the CCW fiber ring. The gate node 1 also includes a second add/drop unit, “A/D Eest,” that adds the OSC signal and new add signal to the clockwise (CW) fiber ring (west) where the gate switch No. 1 is in the CW fiber ring. The node gate 2 is similarly constructed except that the gate switch No. 2 is in the CCW fiber ring and the node VOA is in the CW fiber ring.

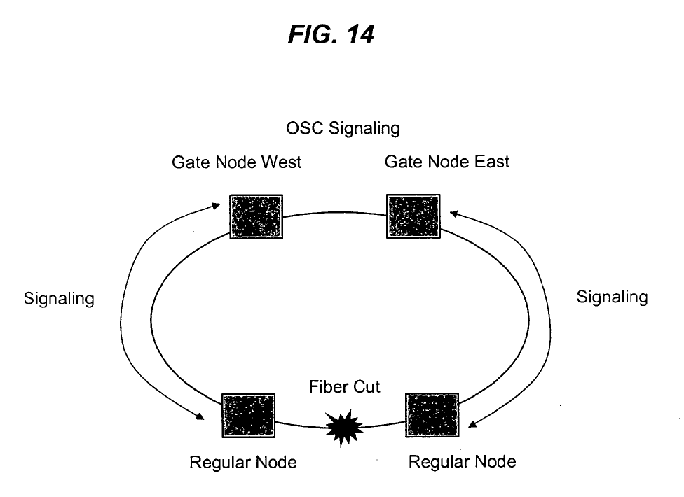

FIG. 14 illustrates the OSC signaling in the ring network of FIG. 1.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understand as requiring that such operations be performed in the particular order shown or in sequential order, or that all illustrated operations be performed, to achieve desirable results.

Only a few implementations are disclosed. However, it is understood that variations and enhancements may be made.

What is claimed is:

1. An optical ring network, comprising:
optical communication nodes connected to form an optical ring,
wherein at least a portion of the nodes are configured to include at least one variable optical attenuator (VOA) which has a maximum optical attenuation at which optical transmission through the VOA is prohibited; and
a protection switching mechanism to detect an optical failure in the ring and to select at least one node to control the VOA in the selected node to prohibit optical transmission when an optical failure is detected.

2. An optical ring network as recited in claim 1, wherein the optical ring is a dual fiber ring.

3. An optical ring network as recited in claim 1, wherein the optical ring is a single fiber ring.

4. An optical ring network as recited in claim 1, wherein the optical ring is either a single fiber ring or a dual-fiber ring.

5. An optical communications method, comprising:
dividing optical communication nodes in a given service area into a plurality of groups of communication nodes that are in different areas within the given service area;
linking communication nodes in each group to form a single broadcast-and-select ring network so that a plurality of broadcast-and-select single ring networks are formed in the groups, respectively;
interconnecting the single ring networks to allow for direct optical communications between any two of the single ring networks so that each single ring network has a junction node that is optically linked to other single ring networks;
providing a gate node in each single ring network that is located at or near a middle location in the single ring network with respect to the junction node, wherein the gate node has a switching mechanism to close or open an optical link at the gate node in response to a control signal; and
closing an optical link in a gate node in a single ring network when there is an optical break in the single ring network while keeping the optical link in gate nodes in other single ring networks closed.

6. An optical communications method as recited in claim 5, further comprising:
using at least one variable optical attenuator in a gate node to achieve the switching mechanism.

7. An optical communications method as recited in claim 5, further comprising:
using at least one optical switch in a gate node to achieve the switching mechanism.

8. An optical communications method as recited in claim 5, further comprising:
using at least one broadband optical coupler at the junction node to couple optical signals between different single ring networks so that any node in any single ring can communicate with any other node in the same ring or different rings.

9. An optical communications method as recited in claim 5, further comprising:
using an optical link to connect two junction nodes in two separate single ring networks.

10. An optical communications method as recited in claim 5, further comprising:
using a single junction node to be shared by and to link all single ring networks.

11. An optical communications method as recited in claim 5, further comprising:
configuring the single ring networks to have equal or approximately equal ring circumferences.

12. An optical communications method as recited in claim 5, comprising:
using an optical switch as the gate switch which has an open position and a close position.

13. An optical communications method as recited in claim 5, comprising:
using a variable optical attenuator as the gate switch which has a maximum attenuation sufficiently to turn off optical transmission.

14. An optical communications method as recited in claim 5, further comprising:
reverting a gate node in a single ring network back to open after a break in the single ring network which causes the gate node to close the optical link at the node gate is repaired.

15. An optical communications method as recited in claim 5, further comprising using at least one optical amplifier in a gate node to achieve the switching mechanism.

16. An optical communications method as recited in claim 5, further comprising:
providing a variable optical attenuator in a communication node to control light power through the communication node; and increasing an attenuation of the variable optical attenuator when a fiber break occurs next to the node to block optical transmission.

17. An optical communications method as recited in claim 16, further comprising:
measuring leakage light through the variable optical attenuator next to the fiber break; and
decreasing the attenuation of the variable optical attenuator upon detection of the leakage light after the fiber break is repaired while simultaneously opening the optical link in the gate node.
